(19) United States
(12) Patent Application Publication
(10) Pub. No.: US 2017/0262446 A1
(43) Pub. Date: Sep. 14, 2017

(54) METHOD AND SYSTEM FOR DESCRIPTION DATABASE CREATION, ORGANIZATION, AND USE

(71) Applicant: Gerald McLaughlin, Las Vegas, NV (US)

(72) Inventor: Gerald McLaughlin, Las Vegas, NV (US)

(21) Appl. No.: 15/064,463

(22) Filed: Mar. 8, 2016

(51) Int. Cl. G06F 17/30; G06F 3/0481; G06Q 30/06

(52) U.S. Cl. CPC G06F 17/3053; G06F 17/30867; G06Q 30/0643; G06F 3/0481

(57) ABSTRACT

A method, computer program product, and system are disclosed. The method, when implemented in a computer system, includes receiving a first set of descriptors, receiving a second set of descriptors, and forming a composite set of descriptors therefrom. The computer system is configured to cause presentation of a visual representation, associated with a product and/or service, in a first user interface displayed by a first remote computer system, and a second user interface displayed by a second remote computer system. The computer system is configured to receive the first set of descriptors via the first user interface, and the second set of descriptors via the second user interface. The forming the composite set of descriptors includes forming an aggregated set of descriptors and performing a weighting operation on the aggregated set of descriptors.

### FIELD OF THE INVENTION

The present invention relates to the characterization of products and/or services, and, more particularly, to a method and system for description database creation, organization, and use.

### BACKGROUND

Computers have become an integral part of the daily lives of millions of individuals across the globe. We use computers, be they desktop computers, tablets, smartphones, or the like, to all manner of ends in this regard. One such purpose is the buying and selling of physical products, services, and the like, but also virtual items such as music, software, content access, premium content, and the like. This area of computer use, sometimes referred to in the generic as electronic commerce, provides us with a vast array of such products and services from which to choose. Unfortunately, such a vast array of offerings comes with a price—identifying the best alternative offered can prove to be something akin to finding the proverbial “needle in a haystack.”

In this regard, present technologies employed to assist end-users with identifying and selecting a desired product or service from the available alternatives are, at best, rudimentary. Simple searching of text provided for a given offering leaves much to be desired. Problems with such an approach include inaccurate descriptions, terse titles, misspellings, poorly chosen search terms, and other such infirmities. Moreover, such an approach can fail to capture the evocative nature of the offering in question, and can miss salient features altogether. If the description has been written by one person, that person may not perceive (and hence not describe) the product in the same way or using the same language as others. The same product or service may be described using different words by people from different regions of the market. Such descriptions, having been written by one person, only capture that one person's perspective.

Such techniques are particularly ineffective in situations in which aspects of the products and/or services are primarily subjective in nature, and so are not susceptible (or are at least unsuited) to description by objective measure. Examples of such difficult-to-quantify offerings include paintings, sculptures, greeting cards, music, and other such offerings, due in part to their creative, expressive nature. Further complicating such an assessment are products and services that have pertinent aspects that are more conceptual in nature (e.g., the “safety” of some products and services, age-appropriate qualities, and other such aspects).

One alternative in assisting a customer with the selection process is the use of customer reviews. Once again, reliance must be placed on both the technology used to collect such reviews, as well as on the accuracy and usefulness of the reviews thus presented. The latter is particularly problematic, given that such reviews may be either few in number (e.g., “expert” reviews), or numerous but uninformed (e.g., customer reviews, provided by “lay”-persons who are providing their opinions with respect to their specific end uses, preferences, situation, and so on). And this is to say nothing of differences in perception from one person to the next—one person's “muted” may well be the next person's “bright.” Further still, search reviews may not exist, may be dated, may only be available for other versions of a given product or service, may be completely silent as to patently evident features or features that are important to the given customer, and/or suffer from other such failings. Another limitation of employing reviews to inform a customer's selection process is that such customer reviews are not, and cannot easily be, combined into a single, easily-used review—the customer is thus forced to read many such reviews to even begin to get a sense of the consensus view of the product or service in question.

The foregoing problems, as well as other such failings, stand as obstacles to the efficient, effective presentation of information regarding products, services, and other such offerings when making such presentation in an electronic commerce environment. That being the case, it is therefore desirable to provide mechanisms for determining and maintaining information relevant to a given offering. Further, it is so desirable to be able to present such information to an end-user in an effective, efficient manner

### SUMMARY OF THE INVENTION

In one embodiment, a method, computer program product, and system according to the methods and systems described herein can, for example, be implemented in a computer system, and includes receiving a first set of descriptors at the computer system, receiving a second set of descriptors at the computer system, and forming a composite set of descriptors therefrom. The computer system is configured to cause presentation of a visual representation in a first user interface displayed by a first remote computer system and presentation of the visual representation in a second user interface displayed by a second remote computer system. The visual representation is associated with a product and/or service. The computer system is configured to receive the first set of descriptors via the first user interface, and the second set of descriptors via the second user interface. Each descriptor of the first set of descriptors is associated with the product and/or service by virtue of having been received in response to the presentation of the visual representation in the first user interface. Each descriptor of the second set of descriptors is associated with the product and/or service by virtue of having been received in response to the presentation of the visual representation in the second user interface. The forming the composite set of descriptors is performed by a processor of the computer system. The forming the composite set of descriptors includes forming an aggregated set of descriptors by aggregating one or more descriptors of the first set of descriptors and one or more descriptors of the second set of descriptors, and performing a weighting operation on the aggregated set of descriptors.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways, and such changes and modifications may be made without departing from concepts such as those disclosed herein and their broader aspects. Other aspects, inventive features, and advantages of systems according to the concepts disclosed herein will become apparent in the non-limiting detailed description set forth below.

### BRIEF DESCRIPTION OF THE DRAWINGS

The present invention may be better understood, and its numerous objects, features and advantages made apparent to those skilled in the art by referencing the accompanying drawings.

FIG. 1 is a block diagram illustrating an example of a network architecture, according to methods and systems such as those disclosed herein.

FIG. 2 is a block diagram illustrating an example of a content delivery architecture, according to methods and systems such as those disclosed herein.

FIG. 3 is a block diagram illustrating an example of a database server architecture, according to methods and systems such as those disclosed herein.

FIG. 4A is a block diagram illustrating an example of a server systems architecture, according to methods and systems such as those disclosed herein.

FIG. 4B is a simplified diagram illustrating an example of information maintained in a content database, according to methods and systems such as those disclosed herein.

FIG. 4C is a simplified diagram illustrating an example of information maintained in a descriptor database, according to methods and systems such as those disclosed herein.

FIG. 5 is a simplified flow diagram illustrating an example of the overall operation of a content delivery architecture, according to methods and systems such as those disclosed herein.

FIG. 6 is a simplified flow diagram illustrating an example of operations performed in generating a composite set of descriptors, according to methods and systems such as those disclosed herein.

FIG. 7A is a simplified flow diagram illustrating an example of operations performed in obtaining one or more sets of descriptors from the perspective of a server system, according to methods and systems such as those disclosed herein.

FIG. 7B is a simplified flow diagram illustrating another example of operations performed in obtaining multiple sets of descriptors from the perspective of a server system, supporting a batch mode technique, according to methods and systems such as those disclosed herein.

FIG. 8A is a simplified flow diagram illustrating an example of operations performed by a remote computer system in providing one or more sets of descriptors to a server system, according to methods and systems such as those disclosed herein.

FIG. 8B is a simplified flow diagram illustrating an example of operations performed by a remote computer system in providing one or more sets of descriptors to a server system, supporting a batch mode technique, according to methods and systems such as those disclosed herein.

FIG. 9 is a simplified flow diagram illustrating an example of operations performed in processing one or more sets of descriptors, according to methods and systems such as those disclosed herein.

FIG. 10 is a simplified flow diagram illustrating an example of operations performed in forming a composite set of descriptors, according to methods and systems such as those disclosed herein.

FIG. 11A is a simplified flow diagram illustrating an example of operations performed in executing a search for product and/or service information from the perspective of a server system, according to methods and systems such as those disclosed herein.

FIG. 11B is a simplified flow diagram illustrating another example of operations performed in executing a search for product and/or service information from the perspective of a remote computer, according to methods and systems such as those disclosed herein.

FIG. 12A is a simplified flow diagram illustrating an example of operations performed in conducting a search for product and/or service information from the perspective of a server system, where the process supports the use of a descriptor cloud and feedback information, according to methods and systems such as those disclosed herein.

FIG. 12B is a simplified flow diagram illustrating an example of operations performed in conducting a search for product and/or service information from the perspective of a remote computer, where the process supports the use of a descriptor cloud and feedback information, according to methods and systems such as those disclosed herein.

FIG. 13 is a simplified flow diagram illustrating an example of operations performed in revising relevance values of descriptors, according to methods and systems such as those disclosed herein.

FIG. 14 is a block diagram depicting a computer system suitable for implementing aspects of systems according to embodiments of systems such as those disclosed herein.

FIG. 15 is a block diagram depicting a network architecture suitable for implementing aspects of systems according to embodiments of systems such as those disclosed herein.

### DETAILED DESCRIPTION

The following is intended to provide a detailed description of an example of the invention and should not be taken to be limiting of the invention itself. Rather, any number of variations may fall within the scope of the invention which is defined in the claims following the description.

### Introduction

Methods and systems such as those described herein provide the ability to create significantly more meaningful, as well as more efficiently searchable, descriptions of products and services than can be created by other approaches available presently. To this end, methods and systems such as those described herein support the creation, organization, and use of descriptors and provide a descriptor database for their storage, as well as providing for the creation, organization, and use of product/service information, which can be maintained, for example, in a content database. In so providing, such methods and systems facilitate the efficient, effective presentation of information regarding products, services, product-service systems, and other such offerings (referred to herein, in the generic, as products and/or services), when making such presentation in, for example, an electronic commerce environment. Further, such methods and systems provide a mechanism for determining and maintaining information relevant to a given offering in an efficient, effective manner, and further still, effect the communication and presentation of such information to an end-user in an effective, efficient manner.

As noted, existing alternatives for identifying products and/or services that meet a customer's needs and desires are fundamentally flawed, in part as a result of the mechanistic qualities and functionalities such systems employ. Further complicating such shortcomings is the intangible, conceptual nature of certain offerings. Further still, such existing alternatives also fail to recognize, and thus fail to capture, associations that may exist as between various offerings in the minds of end-users. In light of these and other infirmities, the ability of such existing alternatives falls well short of meeting customer expectations, and so results in a less than optimal customer experience.

To address such failings, methods and systems such as those described herein provide for and employ descriptors. A descriptor is a unit of information that is related in some fashion to a product and/or service. Thus, by obtaining descriptors from one or more analysts in a manner such as that described herein (also referred to herein as characterization), such methods and systems are capable of not only collecting, combining, maintaining, and using quantitative information (e.g., objective information that describes the product/service offered in literal terms, such as physical dimensions), but are also capable of collecting, combining, maintaining, and using subjective information (e.g., subjective information as to the impressions and perceptions evoked by such products and/or services in conceptual terms, such as degree, emotion evoked, conceptual relationships, and/or the like). In so doing, such methods and systems are able to quickly and accurately present products and/or services that better meet the expectations, needs, and desires of customers. By capturing “impressions,” “feelings evoked,” and other such subjective qualities, these methods and systems allow for the presentation of products and/or services that might otherwise go unnoticed, but which may still be related to the given product and/or service in a subjective sense. Such descriptors can be identified in any convenient manner, including an assigned numerical value, a hash value (e.g., by hashing the descriptor), and/or other such identifying information. As will be appreciated in light of the present disclosure, the use of a hashing function to generate such descriptor identifiers provides an efficient mechanism for communicating, storing, searching, and otherwise processing descriptors such as those described herein (e.g., such descriptor identifiers, also referred to herein as tokens, each being a value of some sort, such as a numerical value, hash value, or the like, that identifies a given descriptor (e.g., “1” identifying “red,” “2” identifying “green,” “3” identifying “blue,” and so on)).

With respect to end-users, methods and systems such as those described herein provide for the comparable concept of a search descriptor, which allows an end-user to provide information that can be used in searching for and identifying products and/or services. Such information can be in the manner of the descriptors provided by analysts, though such need not necessarily be the case, and so can be in the form of textual information, graphical information, haptic information, and/or other forms of information. Further, methods and systems such as those described herein provide functionality that provides for the recognition of, and so the ability to capture and represent, associations and relationships such as those that may exist between various products and/or services in the minds of analysts, and ultimately, end-users.

Such methods and systems also comprehend the notion of “relates to”—a product (e.g., an alarm clock) relates to the concept of “morning,” and so, as one example, one might relate a rooster to the concept of “alarm clock.” By accounting for such alternatives and presenting them to the customer, methods and systems according to embodiments described herein provide improved customer experience when interacting with a website or other such construct in the identification and selection of a product and/or service. Further, such methods and systems are also able to account for differences in perception, and by providing alternatives based on such relationships and perceptions, are able to provide end-users with the ability to more accurately and efficiently refine searches for the products and/or services being sought.

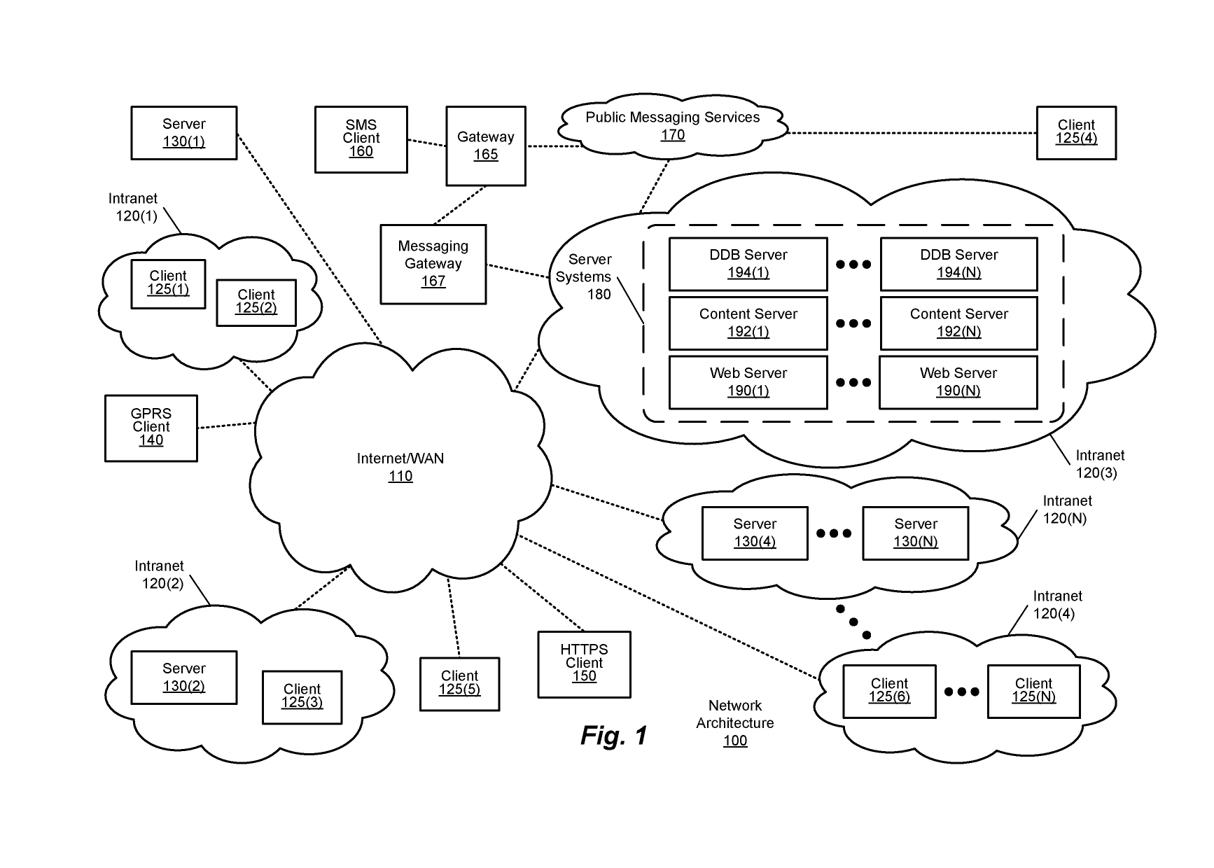

Thus, one of the advantages provided by methods and systems such as those described herein is the creation of a more useful description of the product and/or service. Such a description is advantageous, in part, because it is based on information (e.g., descriptors, such as words, phrases, selections, graphical feedback, and so on) provided by multiple analysts in response to the presentation of some manner of perceptible information (e.g., a descriptor such as a visual representation (e.g., image, animation, video clip, and the like), audible information, textual information, haptic information, or other perceptible information) presentable by some manner of user interface, whether that be visual, mechanical, audible, or otherwise. Such a process provides more meaningful descriptors than would otherwise be the case, as well as ensuring that relevant features of and impressions made by a given product and/or service are captured by the process. In so doing, methods and systems such as those described herein improve the likelihood that a given point of view regarding a feature of a product and/or service is not inadvertently excluded in gathering descriptors for the given product and/or service. Further, such approaches allow methods and systems such as those described herein to weight such descriptors using notions of consensus, importance to the author, producer, manufacturer, or other such entity (as appropriate to the products and/or services in question), use by end-users, and so on. This results in descriptors that provide a markedly better (e.g., more comprehensive), more usable, more easily searched description of products and/or services than might be created using another approach, as will be apparent from the discussions below in connection with FIGS. 1-15.

### Example Network Architecture

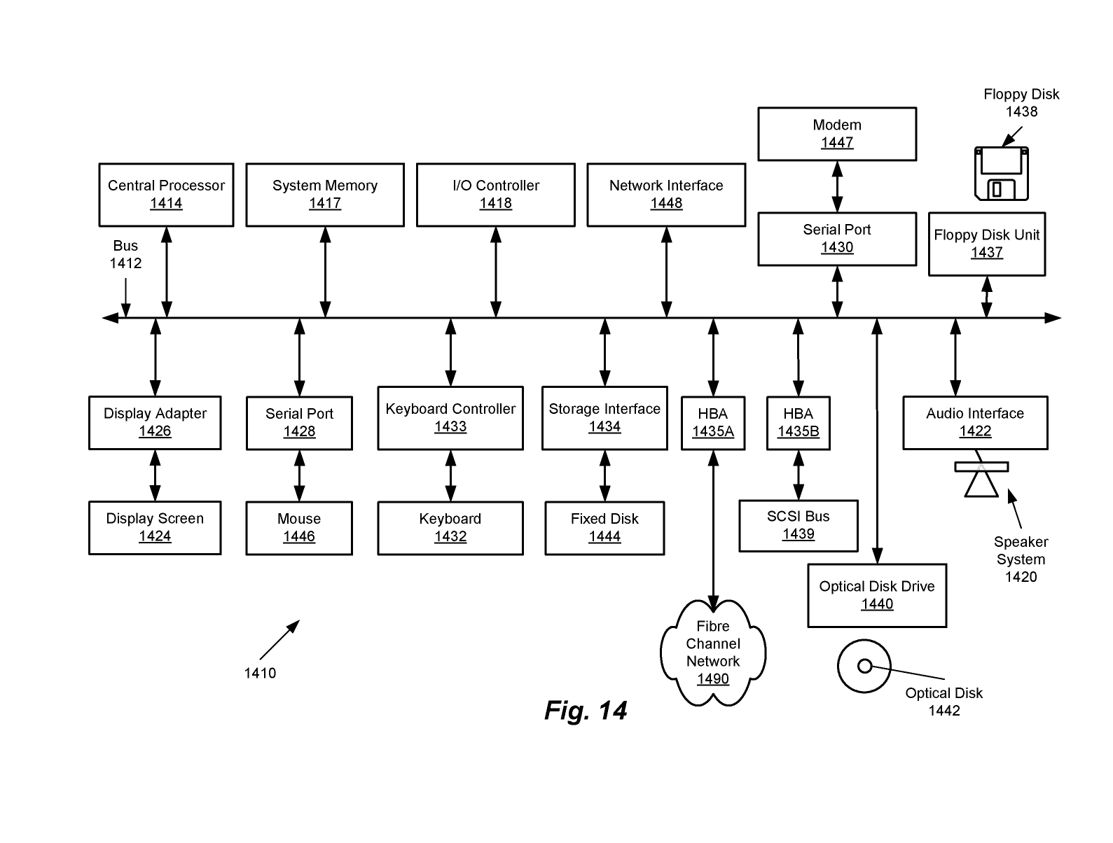

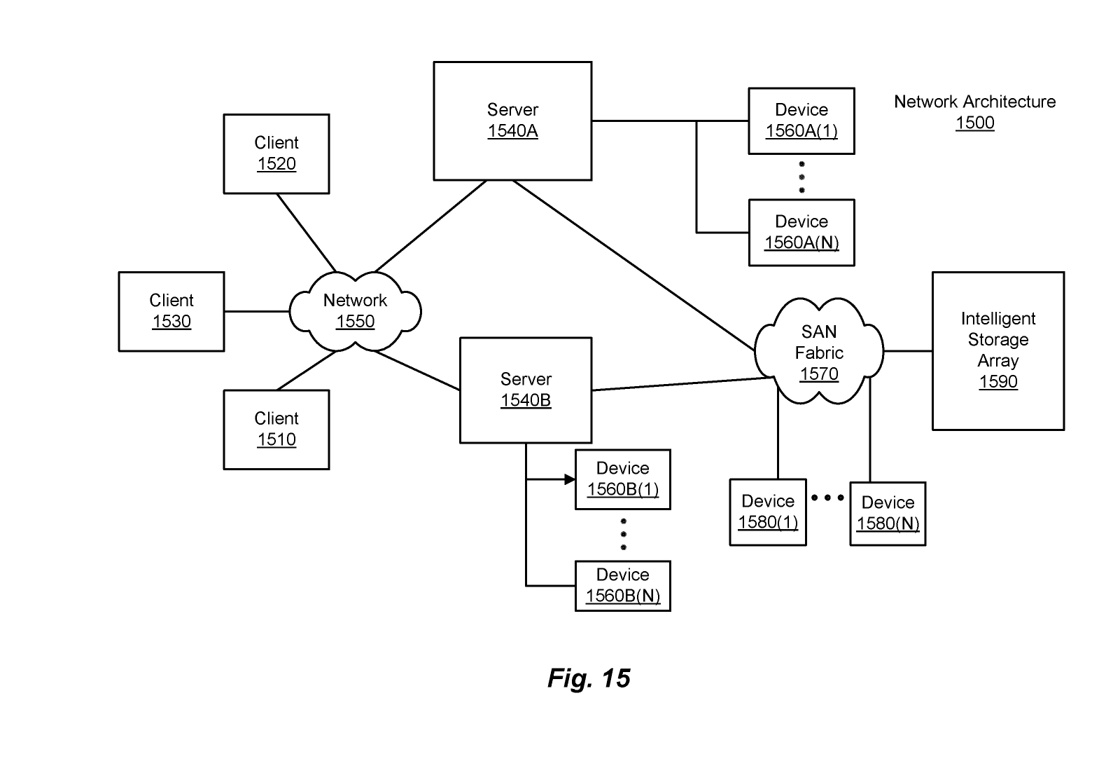

FIG. 1 is a block diagram illustrating an example of a network architecture 100 that includes a server system according to one embodiment. Network architecture 100 includes an internetwork (depicted in FIG. 1 as an internet/wide area network (WAN) 110), which is configured to couple a number of intranets to one another (depicted in FIG. 1 as intranets 120(1)-(N)). Intranets 120(1)-(N), in turn, can include a number of components, such as one or more clients (depicted in FIG. 1 as clients 125(1)-(N)) and/or servers (depicted in FIG. 1 as servers 130(1)-(N)). Clients 125(1)-(N) and/or servers 130(1)-(N) can, for example, be implemented using computer systems such as those described in connection with FIGS. 14 and 15. Internet/WAN 110 thus communicatively couples intranets 120(1)-(N) to one another, thereby allowing clients 125(1)-(N) and servers 130(1)-(N) to communicate with one another (and can, in certain embodiments, provide for the servers of intranets 120(3) and 120(N), for example, to operate as cloud-based server systems). As is depicted in FIG. 1, clients 125(1)-(N) can be communicatively coupled to one another and to servers 130(1)-(N) as part of one of intranets 120(1)-(N), or directly via internet/WAN 110. Similarly, servers 130(1)-(N) can be coupled via intranet/WAN 110 via a direct connection to intranet/WAN 110, or as part of one of intranets 120(1)-(N).

Network architecture 100 also provides for communication via intranet/WAN 110 using one or more other devices. Such devices can include, for example, a general packet radio service (GPRS) client 140 (e.g., a “smart phone,” a “tablet” computer, or other such mobile device), a secure web client (depicted in FIG. 1 as a secure hypertext transfer protocol client 150), and a basic cellular phone (e.g., using standard texting or other communication protocols, and depicted in FIG. 1 as a simple messaging service (SMS) client 160). HTTPS client 150 can be, for example, a laptop computer using the HTTP Secure (HTTPS) protocol. Support for GPRS clients, SMS clients, HTTP clients, and the like thereby provide users with communication functionality according to an embodiment in a mobile environment. As is also depicted in FIG. 1, SMS client 160 can communicate via internet/WAN 110 via several channels. SMS client 160 can communicate directly, for example, with a gateway 165, which, in turn, communicates with internet/WAN 110 via a messaging gateway 167 and, optionally, elements within intranet 120(3), for example. Alternatively, SMS client 160 can, via gateway 165, communicate with intranet 120(3) (and so, internet/WAN 110) via public messaging services 170 to which gateway 165 and intranet 120(3) are connected. As is also depicted in FIG. 1, a client 125(4) is also able to communicate via internet/WAN 110 by way of public communication services 170 and intranet 120(3). In order to support such communications, as well as other communications according to various embodiments, intranet 120(3) includes server systems 180, as well as (optionally) providing for a number of clients (not shown), in the manner of intranet 120(2).

Server systems 180 include a number of components that allow server systems 180 to provide various functionalities (e.g., supporting various communications, web-based services, cloud-based services, enterprise services, and so on). Among these components, in certain embodiments, are a number of servers, which can be implemented in hardware and/or software. Examples of such servers include web servers (depicted in FIG. 1 as web servers 190(1)-(N)), content servers (depicted in FIG. 1 as content servers 192(1)-(N)), and descriptor database servers (depicted in FIG. 1 as descriptor database servers 194(1)-(N)).

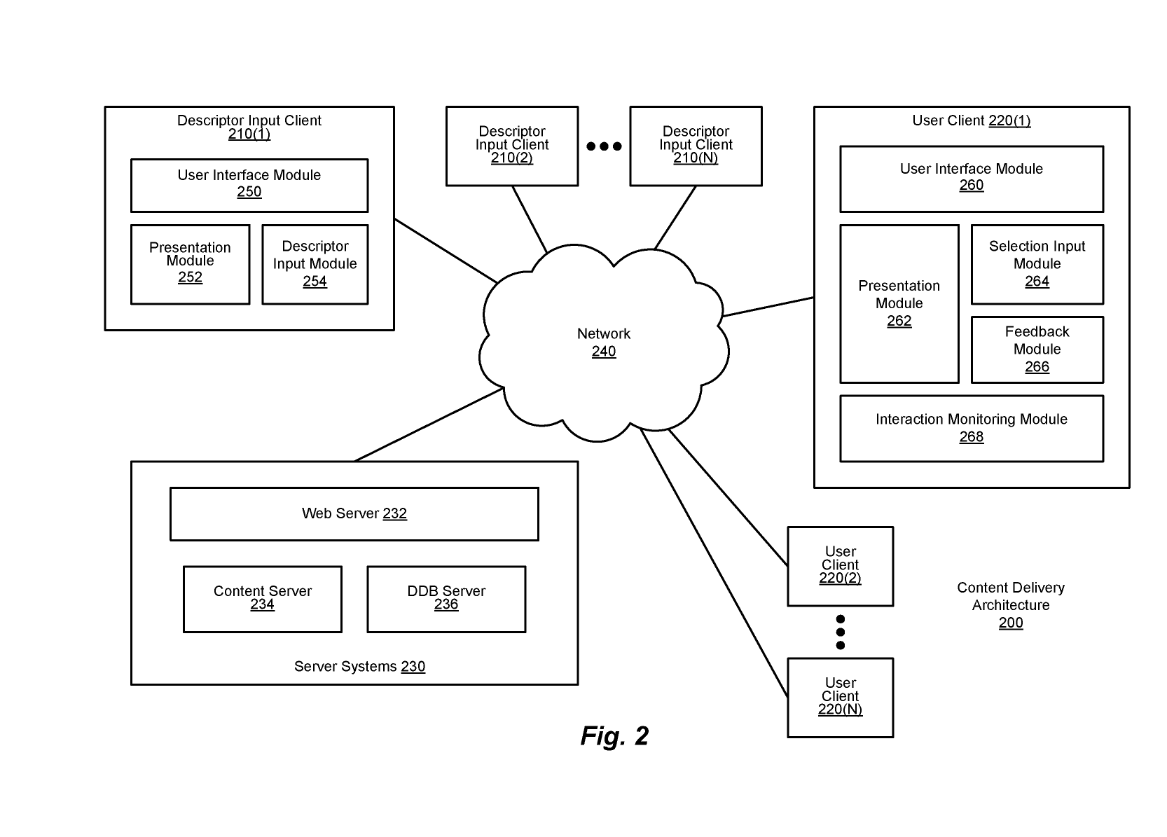

Servers such as those included in server systems 180 are designed to include hardware and/or software configured to facilitate functionalities that support operations according to the concepts disclosed herein, among other possible such components and mechanisms, in communication with one another (e.g., directly, via various application programming interfaces (APIs) and/or other such interfaces, and/or other such mechanisms and/or constructs). As will be discussed in greater detail in connection with FIG. 2, the server systems of server systems 180 provide such functionality, for example by presenting end-users with a website (functionality effected by, for example, web servers 190(1)-(N)). In so doing, web servers 190(1)-(N) present information collected, generated, organized, and maintained by one or more descriptor database servers 194(1)-(N) and/or content servers 192(1)-(N). Such a website can be accessed by an end-user using a client computing device such as one or more of clients 125(1)-(N), GPRS client 140, HTTPS client 150, and/or SMS client 160. As will be appreciated in light of the present disclosure, the ability to support such functionality on mobile devices such as those described herein is of importance, as mobile electronic commerce is fast becoming an important facet of today's online environment. In providing functionality such as that described herein, network architecture 100 is able to support the identification and presentation of relevant product/service information in an efficient, effective manner

It will be appreciated that, in light of the present disclosure, the variable identifier “N” is used in several instances in various of the figures herein to more simply designate the final element of a series of related or similar elements (e.g., intranets 120(1)-(N), clients 125(1)-(N), and servers 130(1)-(N)). The repeated use of such variable identifiers is not meant to imply a correlation between the sizes of such series of elements. The use of variable identifiers of this sort in no way is intended to (and does not) require that each series of elements have the same number of elements as another series delimited by the same variable identifier. Rather, in each instance of use, variables thus identified may represent the same or a different value than other instances of the same variable identifier.

As will be appreciated in light of the present disclosure, processes according to concepts embodied by systems such as those described herein include one or more operations, which may be performed in any appropriate order. It is appreciated that operations discussed herein may consist of directly entered commands by a computer system user or by steps executed by application specific hardware modules, but the preferred embodiment includes steps executed by software modules. The functionality of steps referred to herein may correspond to the functionality of modules or portions of modules.

The operations referred to herein may be modules or portions of modules (e.g., software, firmware or hardware modules). For example, although the described embodiment includes software modules and/or includes manually entered user commands, the various example modules may be application specific hardware modules. The software modules discussed herein may include script, batch or other executable files, or combinations and/or portions of such files. The software modules may include a computer program or subroutines thereof encoded on computer-readable storage media.

Additionally, those skilled in the art will recognize that the boundaries between modules are merely illustrative and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, those skilled in the art will recognize that the operations described in example embodiment are for illustration only. Operations may be combined or the functionality of the operations may be distributed in additional operations in accordance with the invention.

Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagram may be executed by a module (e.g., a software module) or a portion of a module or a computer system user using, for example, a computer system such as computer system 210. Thus, the above described method, the operations thereof and modules therefor may be executed on a computer system configured to execute the operations of the method and/or may be executed from computer-readable storage media. The method may be embodied in a machine-readable and/or computer-readable storage medium for configuring a computer system to execute the method. Thus, the software modules may be stored within and/or transmitted to a computer system memory to configure the computer system to perform the functions of the module, for example.

Such a computer system normally processes information according to a program (a list of internally stored instructions such as a particular application program and/or an operating system) and produces resultant output information via I/O devices. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Such a computer system typically includes multiple computer processes executing “concurrently.” Often, a computer system includes a single processing unit which is capable of supporting many active processes alternately. Although multiple processes may appear to be executing concurrently, at any given point in time only one process is actually executed by the single processing unit. By rapidly changing the process executing, a computer system gives the appearance of concurrent process execution. The ability of a computer system to multiplex the computer system's resources among multiple processes in various stages of execution is called multitasking. Systems with multiple processing units, which by definition can support true concurrent processing, are called multiprocessing systems. Active processes are often referred to as executing concurrently when such processes are executed in a multitasking and/or a multiprocessing environment.

The software modules described herein may be received by such a computer system, for example, from computer readable storage media. The computer readable storage media may be permanently, removably or remotely coupled to the computer system. The computer readable storage media may non-exclusively include, for example, any number of the following: magnetic storage media including disk and tape storage media, optical storage media such as compact disk media (e.g., CD-ROM, CD-R, etc.) and digital video disk storage media, nonvolatile memory storage memory including semiconductor-based memory units such as FLASH memory, EEPROM, EPROM, ROM or application specific integrated circuits; volatile storage media including registers, buffers or caches, main memory, RAM, and the like; and other such computer-readable storage media. In a UNIX-based embodiment, the software modules may be embodied in a file, which may be a device, a terminal, a local or remote file, or other such devices. Other new and various types of computer-readable storage media may be used to store the software modules discussed herein.

Example Architectures for Characterization of Products and/or Services

FIG. 2 is a block diagram illustrating an example of a content delivery architecture, according to methods and systems such as those disclosed herein. The content delivery architecture of FIG. 2 (depicted in FIG. 2 as a content delivery architecture 200) presents a simplified illustration of the salient features of network architecture 100. That being the case, content delivery architecture 200 is depicted as including a number of client computer systems (e.g., in the manner of clients 125(1)-(N)) and server systems (e.g., in the manner of server systems 180). Content delivery architecture 200 thus includes a number of descriptor input clients (depicted in FIG. 2 as descriptor input client 210(1)-(N)), user clients (depicted in FIG. 2 as user clients 220(1)-(N)), and server systems (depicted in FIG. 2 as server systems 230). In the manner of server systems 180, server systems 230 include one or more servers, each of which support one or more of the functionalities described herein. In the example presented in FIG. 2, server systems 230 include a web server 232, a content server 234, and a descriptor database (DDB) server 236. Descriptor input clients 210(1)-(N) and user clients 220(1)-(N) access the elements of server systems 230 by way of a network 240.

As was noted with respect to network architecture 100, the various clients depicted in FIG. 2 have access to the server systems thereof. In a similar fashion, server systems 230 can be accessed by, for example, one or more analysts and/or end-users, using one or more clients of content delivery architecture 200. More specifically, an analyst can employ a descriptor input client such as descriptor input client 210(1), while an end-user can employ a user client such as user client 220(1).

With regard to the former, descriptor input client 210(1) includes a user interface module 250, a presentation module 252, and a descriptor input module 254. Product/service information is received at presentation module 252 of descriptor input client 210(1) from content server 234 via web server 232. User interface module 250 presents an analyst employing descriptor input client 210(1) with a user interface, in which product/service information is presented. As noted elsewhere herein, product/service information presented to an analyst can include, for example, a visual representation (e.g., an image, animation, video clip, or the like), audible representation (e.g., spoken word, or the like), haptic information, an image of text (e.g., an image of three-dimensional words), a narrative of some sort (e.g., a short story, a passage from a book, a novel, a magazine article, or any other sort of such information), meta-information regarding presentable information, music, and/or any other sensory information, so long as such sensory information is perceptible in some way by human senses. For example, the aforementioned visual representation can be presented in a user interface displayed on a computer's display.

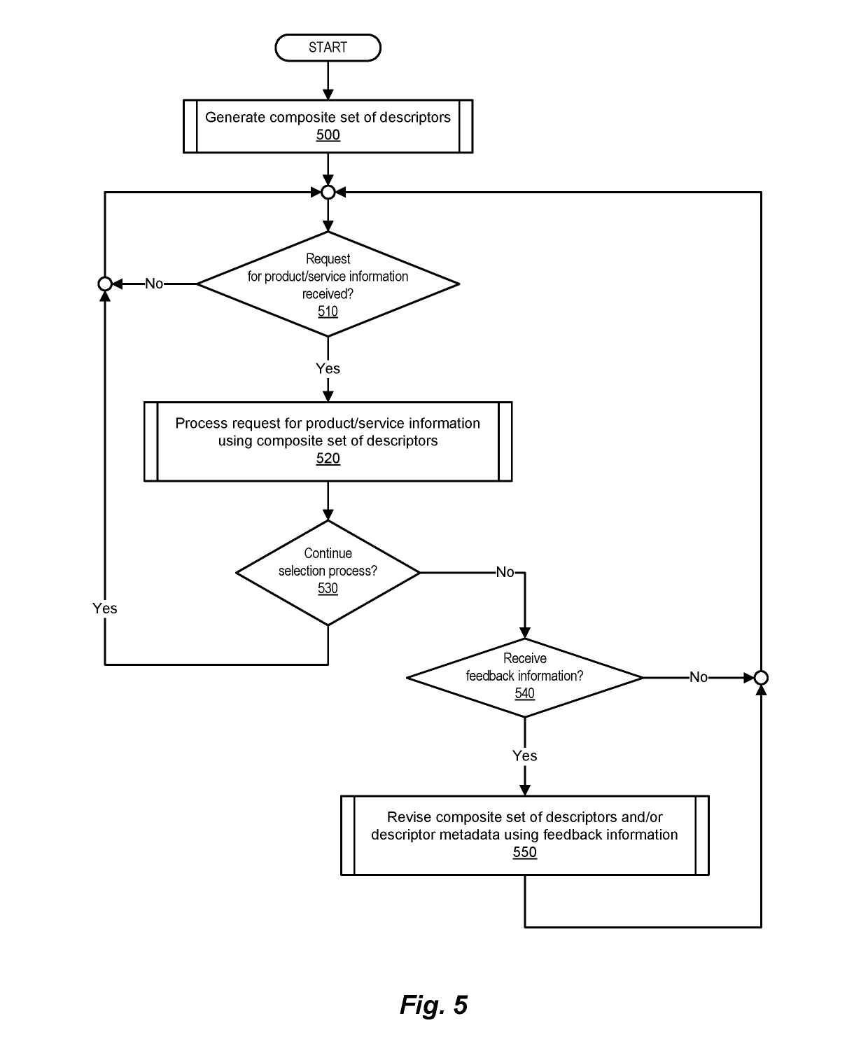

The product/service information is thus presented, for example, in the user interface displayed by a display of descriptor input client 210(1) by way of presentation module 252 and user interface module 250. In turn, the analyst enters (or otherwise communicates) one or more descriptors, which are received via user interface module 250 and collected by descriptor input module 254. Descriptor input module 254 then communicates, at the appropriate point, the descriptors thus collected to descriptor database server 236. As will be appreciated in light of the present disclosure, such a process can be performed by multiple analysts in parallel, and also employ a “batch” approach (in which visual representations representative of multiple products/services are sent to the analyst for review, and the descriptors for each returned subsequently). Such processes are described in greater detail in connection with FIGS. 5-13, below. Descriptors provided by a given analyst can be analyzed in terms of feedback from various entities (e.g., other analysts, authors, manufacturers, service providers, end-users, and other stakeholders), and in so doing, subject the analyst to a rating system (resulting in what is referred to herein as a reputation). Such a rating system includes, but is not limited to, a peer-review/reviewer-based review process, a feedback process that allows end-users to provide ratings of descriptors provided by the analyst, ratings by authors/producers/manufacturers, and other such mechanisms, in order to provide information regarding and control over the quality of such descriptors, and/or facilitate weighting of such descriptors based on a given analyst's reputation (e.g., the perceived reliability and accuracy of descriptors based on an analyst's past “performance”). As will be appreciated in light of the present disclosure, descriptors provided by such analysts are searchable in certain embodiments, as is described in greater detail elsewhere herein. As will also be appreciated, descriptor identifiers can be used in place of such descriptors in order to effect more efficient communications, as a result of the reduced size of such descriptor identifiers, as compared to the size of their respective descriptors (which is particularly true for large descriptors such as graphics and other visual data, as well as audio information). To this end, by building a database of descriptors (and their associated descriptor identifiers), a descriptor input client such as descriptor input client 210(1) is able to identify descriptors simply by their corresponding descriptor identifiers, and thus minimize bandwidth requirements of communicating such information (e.g., not only by reducing the amount of data communicated, but also by sending only descriptor identifiers, thereby allowing the DDB server to determine which descriptors are already present in its descriptor database, and requesting that the descriptor input client send only those descriptors not already stored in the descriptor database).

Conversely, an end-user (e.g., a customer) can access a website presented by web server 232 using one of user clients 220(1)-(N). For example, a customer can access such a website served by web server 232 using user client 220(1) (also referred to herein as a remote computer system, or more simply, a remote computer). User client 220(1) is depicted as including a user interface module 260, a presentation module 262, a selection input module 264, a feedback module 266, and an interaction monitoring module 268. User client 220(1) presents pages of the website by way of user interface module 260 and presentation module 262. In turn, the customer can interact with the user interface generated by user interface module 260 in a number of ways, in order to search for and identify products and/or services. For example, a customer can use such a user interface to provide one or more search descriptors for use in searching for and identifying products and/or services. As noted earlier, and as will be described in greater detail subsequently, such a search descriptor is a unit of information that is related in some fashion to a product and/or service that can be used in the aforementioned searching for and identifying products and/or services. Another example of functionality supported by embodiments of a user interface according to the present disclosure is one supporting a selection process, in which the customer selects one or more selections related to the offering desired and/or makes other indication as to the product/service desired (particularly effective when using predefined descriptor identifiers). As will be appreciated in light of the present disclosure, these and other approaches can be used alone or combined in a number of ways, thereby providing the end-user with unprecedented flexibility in searching for and identifying products and/or services.

Such search descriptors (or other indications) are received by selection input module 264 via user interface 260, communicated to server systems 230 via network 240. Server systems 230, and more particularly content server 234 in conjunction with descriptor database server 236, identify products and/or services that best meet the desires, preference, and so on, of the customer, based on the information received. In response, product/service information (e.g., a visual representation related to the products and/or services) thus identified and retrieved is sent to user client 220(1). This information is then presented in the user interface by way of presentation module 262 and user interface module 260. As will be described in more detail subsequently, feedback module 266 provides support for obtaining user feedback from the customer in an explicit fashion. That being the case, feedback module 266 presents the customer with feedback alternatives (e.g., product rating input, experience rating, and the like) via user interface module 260. Similarly, interaction monitoring module 268 monitors interactions between the customer and the user interface. Such monitoring can be performed before, during, and/or after the selection process, as well as with respect to any other interactions with the website in question. Here again, by using descriptor identifiers where appropriate and advantageous, communication bandwidth and storage consumption can be minimized, and more efficient use of computing resources achieved. As before, examples of the foregoing processes are provided and described in greater detail in connection with FIGS. 5-13, below.

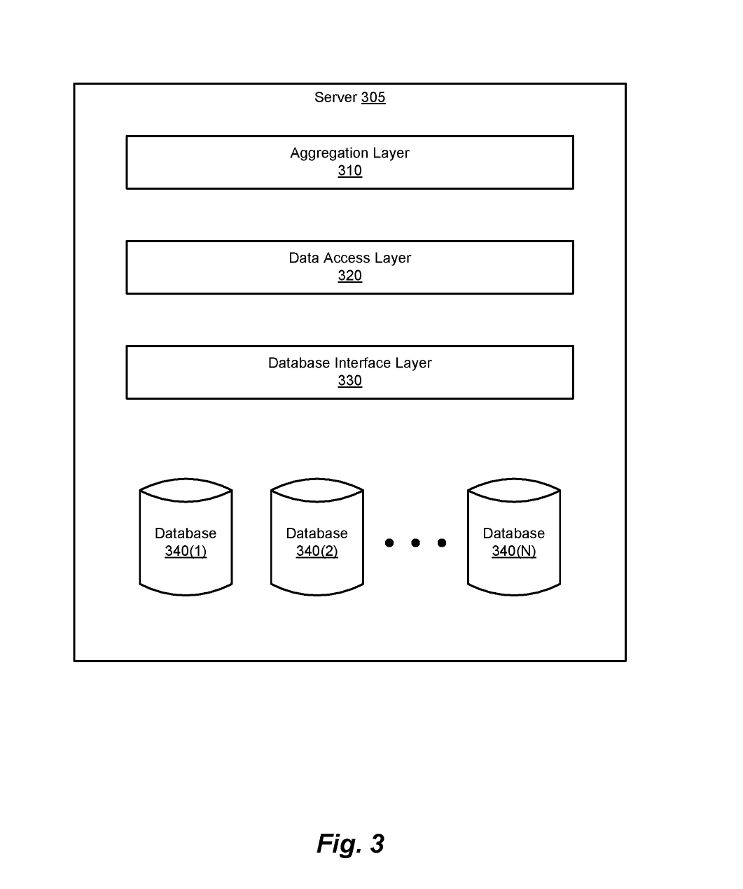

FIG. 3 is a block diagram illustrating an example of a database server architecture, according to methods and systems such as those disclosed herein. The database server architecture of FIG. 3 (depicted in FIG. 3 as a database server architecture 300) includes a server 305. In turn, server 305 includes an aggregation layer 310, a data access layer 320, and a database interface layer 330. An aggregation layer such as aggregation layer 310 facilitates the gathering and organization of information from various information sources appropriate to the information administered and maintained by server 305. For example, in certain embodiments, components within an aggregation layer of a server such as content server 234 receive and organize information (e.g., one or more search descriptors, one or more selections, interaction information, end-user feedback, and/or other such information) from one or more user clients such as user clients 220(1)-(N). Such components can include, for example, modules such as content processing modules and the like. Similarly, components within an aggregation layer of a server such as DDB server 236 receive and organize one or more descriptors/sets of descriptors from one or more descriptor input clients such as descriptor input clients 210(1)-(N). Such components can include, for example, modules such as descriptor processing modules and the like. As will be appreciated in light of the present disclosure, such aggregation layers also provide, in turn, functionality that supports distribution of information such as that maintained in the databases or their respective servers.

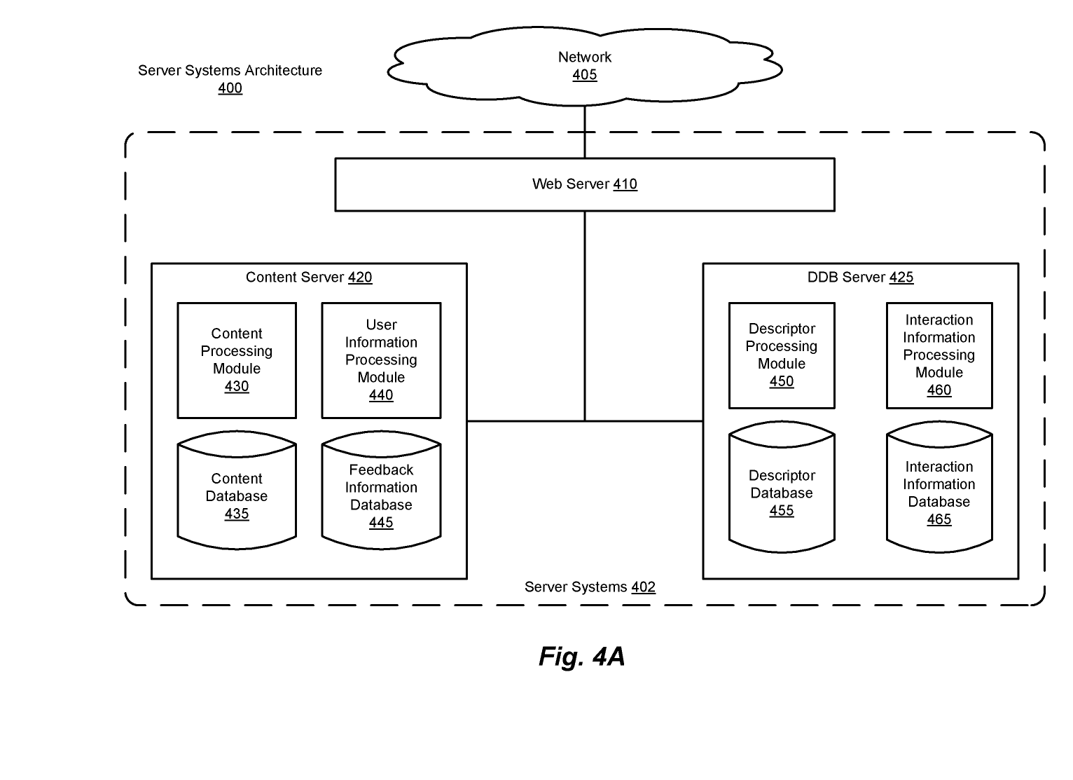

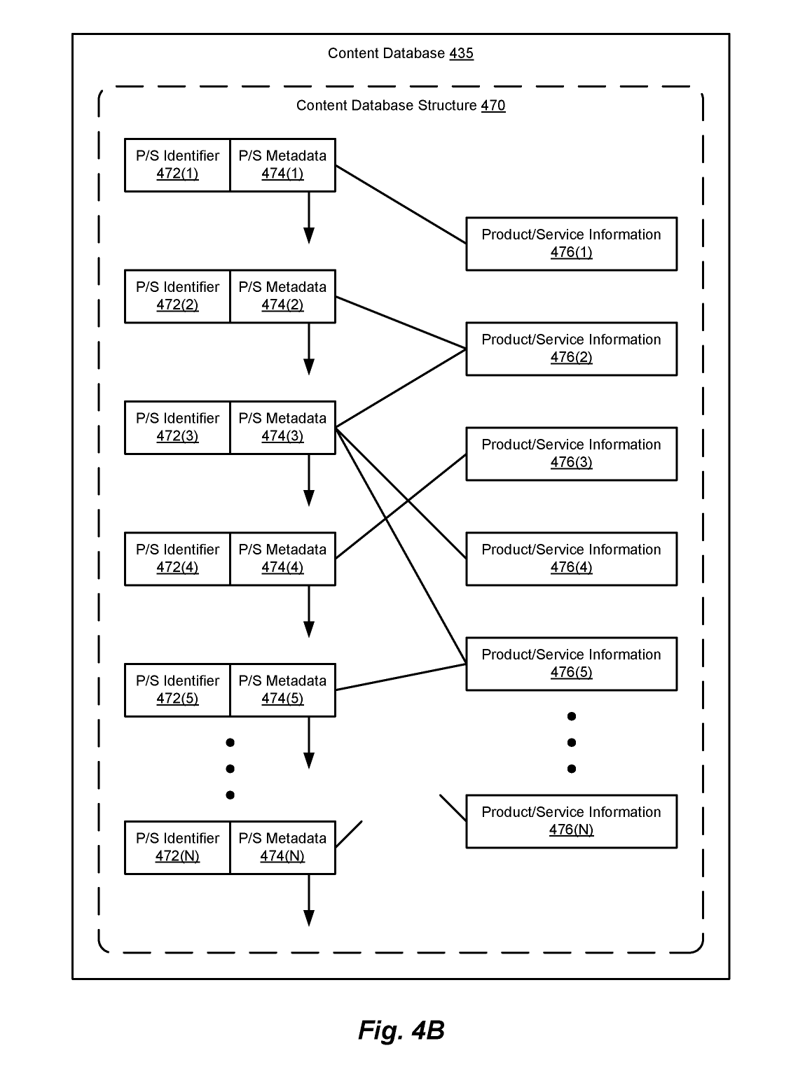

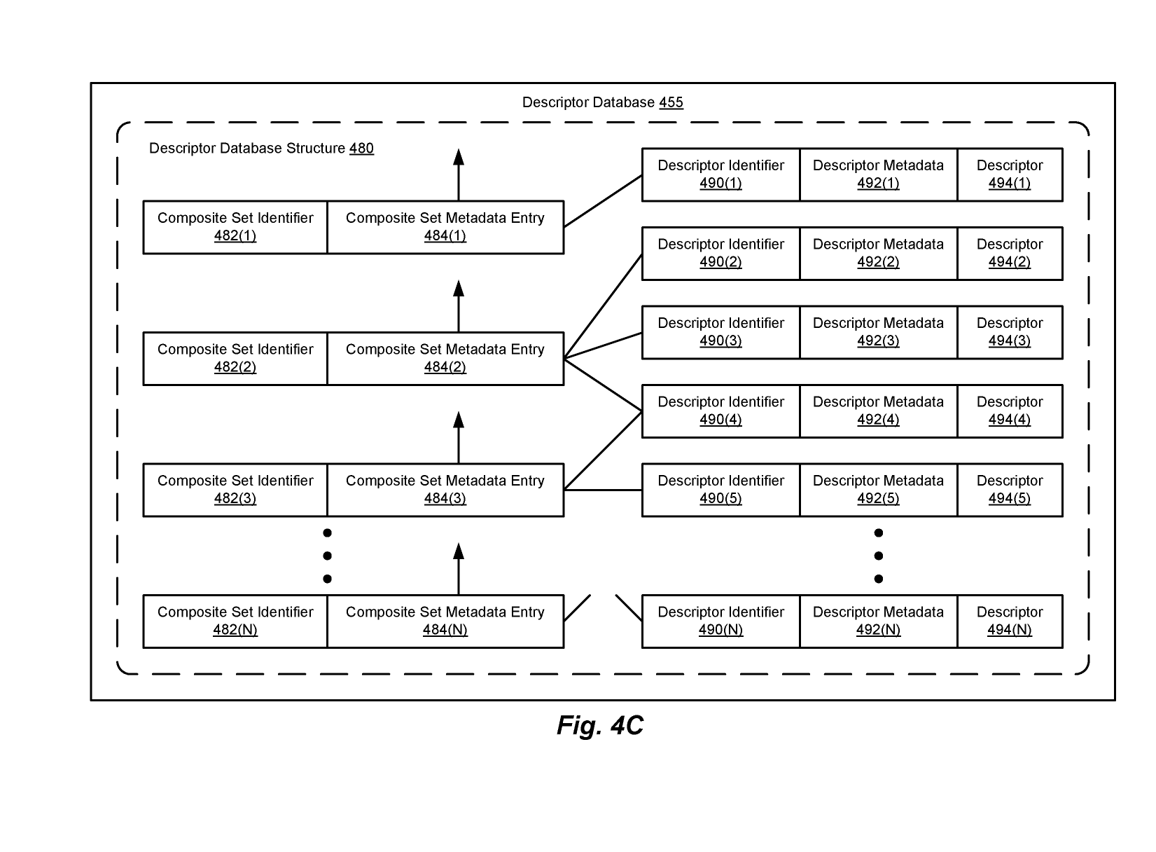

Situated between aggregation layer 310 and database interface layer 330 is data access layer 320, which supports storage/retrieval of aggregated data to/from one or more databases. Data access layer 320 facilitates such storage/retrieval by using a common structure to provide such aggregated data. Data access layer 320 facilitates access to such databases (depicted in FIG. 3 as databases 340(1)-(N)) via database interface layer 330. Database interface layer 330 facilitates communication of aggregated data using the common structure to databases 340(1)-(N) in a structure appropriate to each of databases 340(1)-(N). As noted, and with particular regard to the discussion of FIG. 2, an arrangement such as database server architecture 300 can be used in the implementation of servers such as content server 234 and descriptor database server 236. To this end, an aggregation layer such as aggregation layer 310 supports the collection of information from multiple sources (e.g., descriptor input clients 210(1)-(N) and user clients 220(1)-(N)), and provides such information for storage in a respective database, via a data access layer such as data access layer 320 (which produces aggregated data in a common structure for storage, and receives data in the common format when retrieving such data) and a database interface layer such as database interface layer 330 (which takes in the aggregated data in the common structure and produces data in a structure appropriate to the database into which the data is to be stored, and conversely, provides data in the common structure when retrieving such data). Such an architecture, in turn, supports the retrieval of such data using the converse process, as noted. Further, server systems such as content server 234 and descriptor database server 236 are able to support multiple processing modules (e.g., such as those described in connection with FIG. 4A), and so permit support for simultaneous interactions with multiple descriptor input clients/user clients in parallel.

FIG. 4A is a block diagram illustrating an example of a server systems architecture, according to methods and systems such as those disclosed herein. The server systems architecture of FIG. 4A (depicted as a server systems architecture 400) includes one or more server systems (depicted in FIG. 4A as server systems 402), which are communicatively coupled to a network 405. As will be appreciated, network 405 allows access to server systems 402 by computer systems such as those depicted in FIGS. 1 and 2.

In the example presented as server systems architecture 400, such computer systems access server systems 402 via network 405 by accessing a web server 410, which presents web pages generated using hyper-text markup language (HTML) or other mechanisms, for example. In so doing, web server 410 “serves” (provides) information to such computer systems from the servers of server systems 402, which can include, for example, a content server 420 and a DDB server 425. In order to present web pages having information regarding products and/or services (referred to herein as products and/or services information, or more simply, product/service information), web server 410 serves at least a portion of such product/service information from content server 420. Content server 420, in order to provide such product/service information, includes a content processing module 430 (in certain embodiments, communicatively coupled to a content database 435) and a user information processing module 440 (in certain embodiments, communicatively coupled to a feedback information database 445). In certain embodiments, content server 420 provides product/service information to web server 410 by invoking content processing module 430, which retrieves product/service information (as well as any associated metadata) from content database 435. As will be appreciated in light of the present disclosure, content processing module 430 and content database 435 (and content server 420, generally) can employ a database server architecture such as database server architecture 300. An example of the structure of such product/service information and its associated metadata is described in connection with FIG. 4B.

Similarly, user information processing module 440, being communicatively coupled to feedback information database 445, provides the ability to store/retrieve feedback information to/from feedback information database 445, in order to maintain information regarding customers' experiences in using a system according to methods and systems such as those described herein. For example, such feedback information can be received directly from customers, in response to a solicitation for such information (e.g., by way of a rating system presented to the customer as part of their use of the website). Such direct feedback can comprehend a customer's experience(s) reflecting the customer's opinion of the alternatives presented (e.g., in terms of the alternatives' perceived relatedness to the product/service desired (i.e., each alternative's “strength of correlation”), the appropriateness of the alternatives presented (e.g., in terms of how well alternatives presented agreed with the customer's tastes, desires, and expectations), and other such factors.

In order to support the searching and identification of product/service information, server systems 402 also provide for a descriptor database server such as DDB server 425. In contrast to the operational nature of content server 420 (i.e., the provision of product/service information by content server 420, in response to receipt of one or more search descriptors and/or other such information), DDB server 425 supports the gathering, processing, and maintenance of information, in the form of descriptors and information related thereto, that is related to the products and services represented by such product/service information. DDB server 425 thus includes a descriptor processing module 450 (in certain embodiments, communicatively coupled to a descriptor database 455) and an interaction information processing module 460 (in certain embodiments, communicatively coupled to an interaction information database 465). Descriptor processing module 450, using, for example, an architecture such as database server architecture 300, stores information to and retrieves information from descriptor database 455. Descriptor processing module 450 receives information (e.g., descriptors in the form of sets of descriptors received from remote computer systems such as descriptor input clients 210(1)-(N)). From such sets of descriptors, composite sets of descriptors are formed, as described in greater detail subsequently. An example of the structure of such descriptors, sets of descriptors, and composite sets of descriptors, as well as associated metadata, are described in connection with FIG. 4C.

Descriptor processing module 450 can also access feedback information in feedback information database 445 by way of communications with content processing module 430 and/or user information processing module 440. The feedback information thus obtained can then be used to revise information related to descriptors stored in descriptor database 455. In so doing, a server systems architecture such as server systems architecture 400 is able to provide an improved customer experience by effecting changes to the information maintained in descriptor database 455 such that the information better reflects customer experiences and expectations.

With further regard to the gathering and maintenance of information useful in improving customer experience, interaction information can be stored in/retrieved from interaction information database 465 by interaction information processing module 460. The interaction information stored in interaction information database 465 can reflect, for example, a customer's interactions with the given website, information regarding product/service selections made, information regarding the customer's navigation through the product/service alternatives presented, and other sources of such interaction information as may be gleaned from a customer's use of and interactions with the website. In a fashion similar to that noted with respect to feedback information, such interaction information can be used in revising information related to descriptors stored in descriptor database 455, and in so doing, improve customer experience by effecting changes to the related information.

Thus, in certain embodiments, feedback information database 445 can include information regarding a customer's explicit feedback with respect to their experience with searching for a desired product and/service, as noted. In contrast, the information maintained in interaction information database 465 can reflect a given customer's interactions with the website, as automatically recorded during those interactions. In the implementation depicted in FIG. 4A, user information processing module 440 and its associated database (feedback information database 445) are implemented as part of content server 420, while interaction information processing module 460 and its associated database (interaction information database 465) are implemented as part of DDB server 425. While other implementations are intended to come within the scope of the present disclosure, the implementation depicted in FIG. 4 is a recognition of the more explicit nature of both content (product/service information) and feedback information, and, correspondingly, the more implicit nature of both descriptors and interaction information. As will be appreciated in light of the present disclosure, however, other arrangements of these components is possible, and, as noted, are intended to come within the scope of the present disclosure. Further, the structures depicted in FIGS. 4B and 4C demonstrate one example of structures that maintain information reflecting such relationships.

FIG. 4B is a simplified diagram illustrating an example of information maintained in a content database, according to methods and systems such as those disclosed herein. The content database depicted in FIG. 4B is an example of a content database such as content database 435. While the internal structure of content database 435 can be implemented in any one of a number of ways, the example depicted in FIG. 4B is described by a content database structure 470. Content database structure 470 includes a number of product/service (P/S) identifiers 472(1)-(N). As depicted in FIG. 4B, each of product/service identifiers 472(1)-(N) is associated with product/service (P/S) metadata 474(1)-(N). Each of product/service metadata 474(1)-(N) can include a variety of information related to one or more products and/or services. This includes information regarding the type of product/service information being maintained, information identifying one or more product/service information entries, information regarding the product(s) and/or service(s) represented by the corresponding product/service information, information identifying the composite set(s) of descriptors associated with the given product/service information, and other such information.

Such products and/or services are represented in FIG. 4B by product/service information that is associated with the given products and/or services. Such product/service information is depicted in FIG. 4B as product/service information 476(1)-(N). As noted earlier, product/service information such as product/service information 476(1)-(N) can be any manner of sensory information that is perceptible in some way by human senses, and includes, but is not limited to, textual information, a visual representation (e.g., an image, animation, video clip, and the like), audible information, haptic information, an image of text (e.g., an image of three-dimensional words), a narrative of some sort (e.g., a short story, a passage from a book, a novel, a magazine article, and/or any other sort of such information), meta-information regarding presentable information, music, and/or any other sensory information that can be presented, for example, by way of a user interface displayed on a computer screen, one or more haptic feedback devices, audio output devices, and other such mechanisms.

As will be appreciated, then, product/service metadata includes information that supports the identification, and so, storage/retrieval of product/service information (one or more product/service information entries associated with the product/service identifier) using that product/service identifier. Further, such product/service metadata can also include information that facilitates identification of one or more composite set(s) of descriptors (using, e.g., one or more composite set identifiers), thereby facilitating an association between the particular product/service information and the descriptors of the one or more composite set(s) of descriptors. In this regard, it will be appreciated that, while only a single such reference is depicted for each such product/service metadata in FIG. 4B (by way of arrows), multiple such references are possible and are intended to come within the scope of this disclosure. As such, multiple references represent a situation in which a given product/service identifier (and so, one or more corresponding product/service information entries) is associated with multiple composite sets of descriptors. Such references are implemented, in certain embodiments, as one or more foreign keys in a database table of a content database containing such product/service metadata, providing access to one or more composite sets of descriptors in another database table in a descriptor database.

FIG. 4C is a simplified diagram illustrating an example of information maintained in a descriptor database, according to methods and systems such as those disclosed herein. The descriptor database depicted in FIG. 4B is an example of a descriptor database such as descriptor database 455. While the internal structure of descriptor database 455 can be implemented in any one of a number of ways, the example depicted in FIG. 4C is described by a descriptor database structure 480. Descriptor database structure 480 includes one or more composite set identifiers (depicted in FIG. 4C as composite set identifiers 482(1)-(N)) and corresponding composite set metadata entries (depicted in FIG. 4C as composite set metadata entries 484(1)-(N)). Each of composite set identifiers 482(1)-(N) is associated with one or more corresponding descriptor identifiers (depicted in FIG. 4C as descriptor identifiers 490(1)-(N)), which associate one or more of composite set identifiers 482(1)-(N) with the corresponding descriptor metadata (one of descriptor metadata 492(1)-(N) depicted in FIG. 4C) and descriptor (one of descriptors 494(1)-(N) depicted in FIG. 4C) associated with the given descriptor identifier. Examples of descriptor identifiers 490(1)-(N) include a numeric value assigned to the given descriptor, a token (e.g., a hash value), and other such identifiers.

Descriptor metadata such as descriptor metadata 492(1)-(N) not only provides for association of a corresponding one of descriptor identifiers 490(1)-(N) and descriptors 494(1)-(N), but also includes information including, for example, frequency of occurrence of the given descriptor, weighting assigned to the given descriptor (weighting value), weighting scale employed (e.g., relative, absolute, source, reputation, and/or the like), relevance value determined for the given descriptor, relevance value scale employed (e.g., relative, absolute, and/or the like), reputation information (e.g., an overall value for the source(s) of the given descriptor), and/or other such information.

Composite set metadata entries 484(1)-(N) can include this and other such information, with respect to the given composite set identifier associated therewith. In fact, in order to provide more efficient storage, such descriptor metadata can include information regarding a number of descriptors that hash to essentially the same descriptor identifier (e.g., by ignoring some number of lower-order bits), and so allow for the more efficient storage of such information. Further, such composite set metadata can also include information that facilitates identification of one or more product/service identifiers (and so, associated product/service information entries), thereby facilitating an association between the given composite set of descriptors and the one or more product/service information entries. In this regard, it will be appreciated that, while only a single such reference is depicted for each such composite set metadata entry in FIG. 4B (by way of arrows), multiple such references are possible and are intended to come within the scope of this disclosure. As such, multiple references represent a situation in which a given composite set identifier is associated with multiple product/service identifiers (and so, one or more corresponding product/service information entries). Such references are implemented, in certain embodiments, as one or more foreign keys in the composite set metadata entry stored in a database table of a descriptor database, providing access to one or more product/service information entries (by way of associated product/service identifiers) stored in another table of a content database. Further, as will be appreciated from the discussion of foreign keys, such database table can, in fact, be stored in the same database (along with feedback information and interaction information), should such an implementation be advantageous and appropriate in the situation at hand, as discussed earlier.

Example Processes for Characterization of Products and/or Services

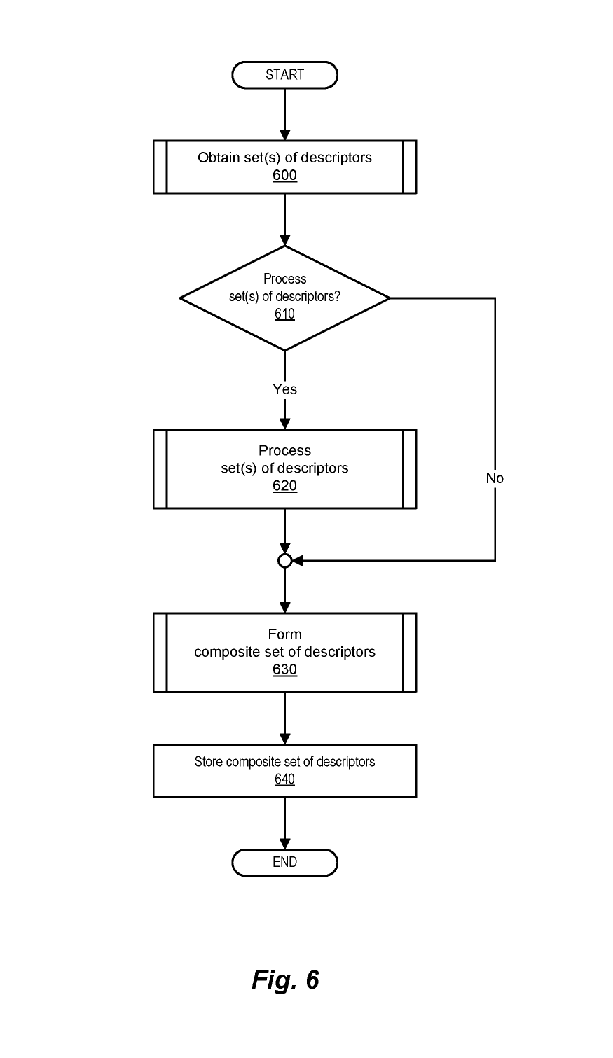

FIG. 5 is a simplified flow diagram illustrating an example of the overall operation of a content delivery architecture, according to methods and systems such as those disclosed herein. In the example of the operation of a content delivery architecture illustrated in FIG. 5, the process begins with the generation of a composite set of descriptors (500). In one embodiment, the generation of a composite set of descriptors includes obtaining one or more sets of descriptors from remote computers and forming the composite set of descriptors from the sets(s) of descriptors thus received. A more detailed discussion of the operations performed in generating a composite set of descriptors and examples relating thereto is discussed in connection with FIGS. 6, 7A, 7B, 8A, 8B, 9, and 10 below.

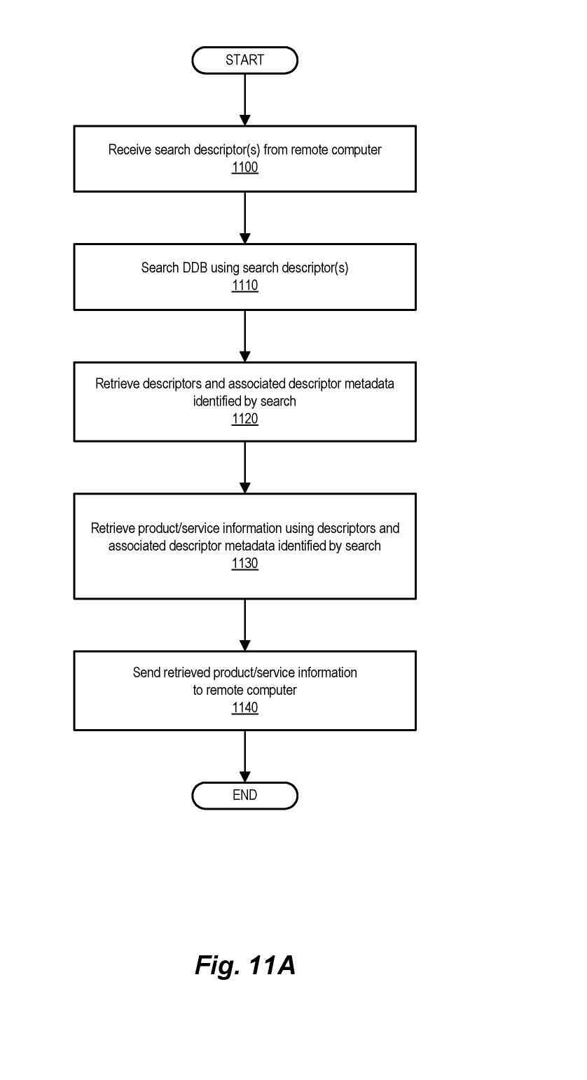

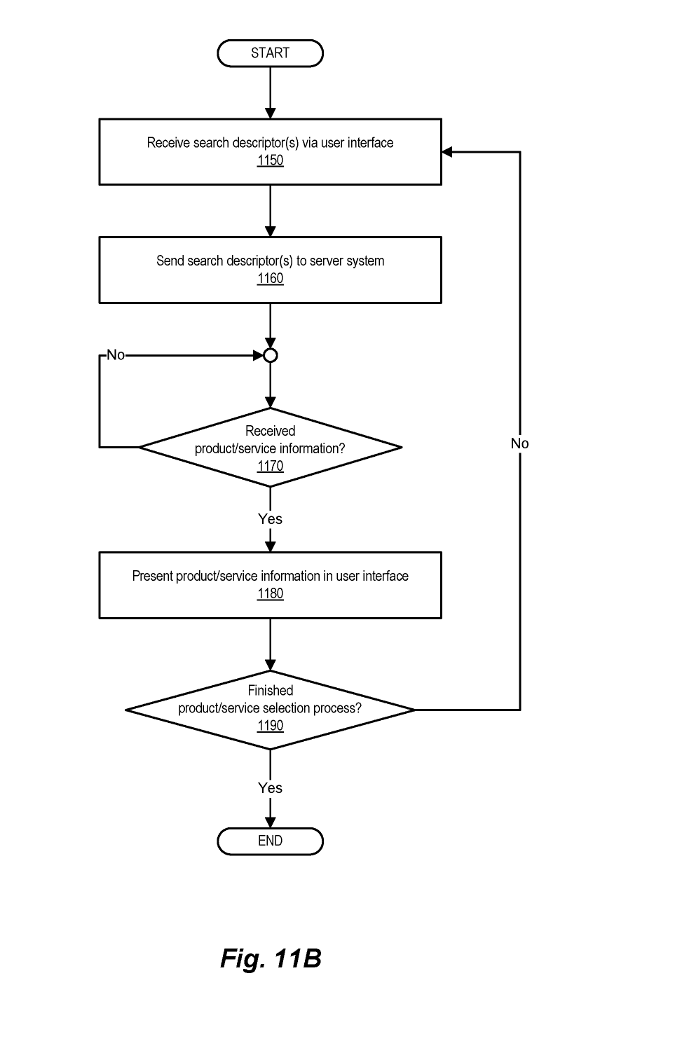

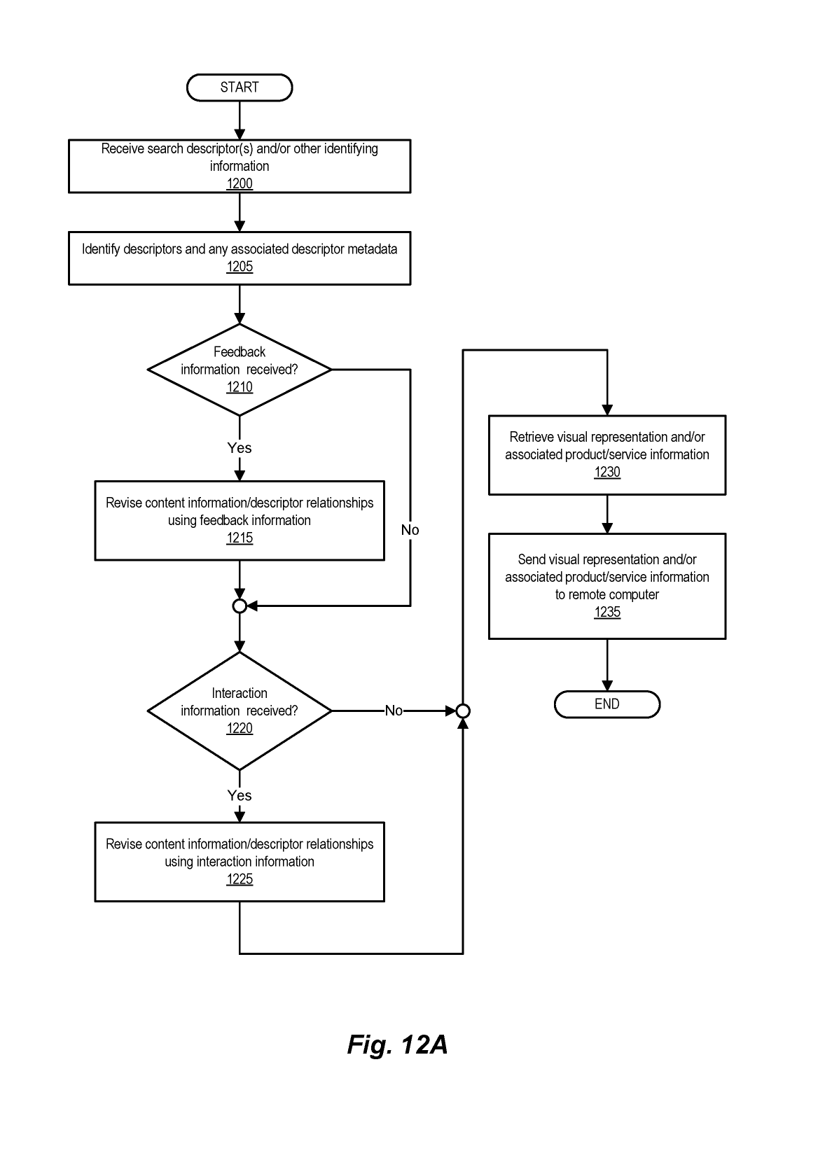

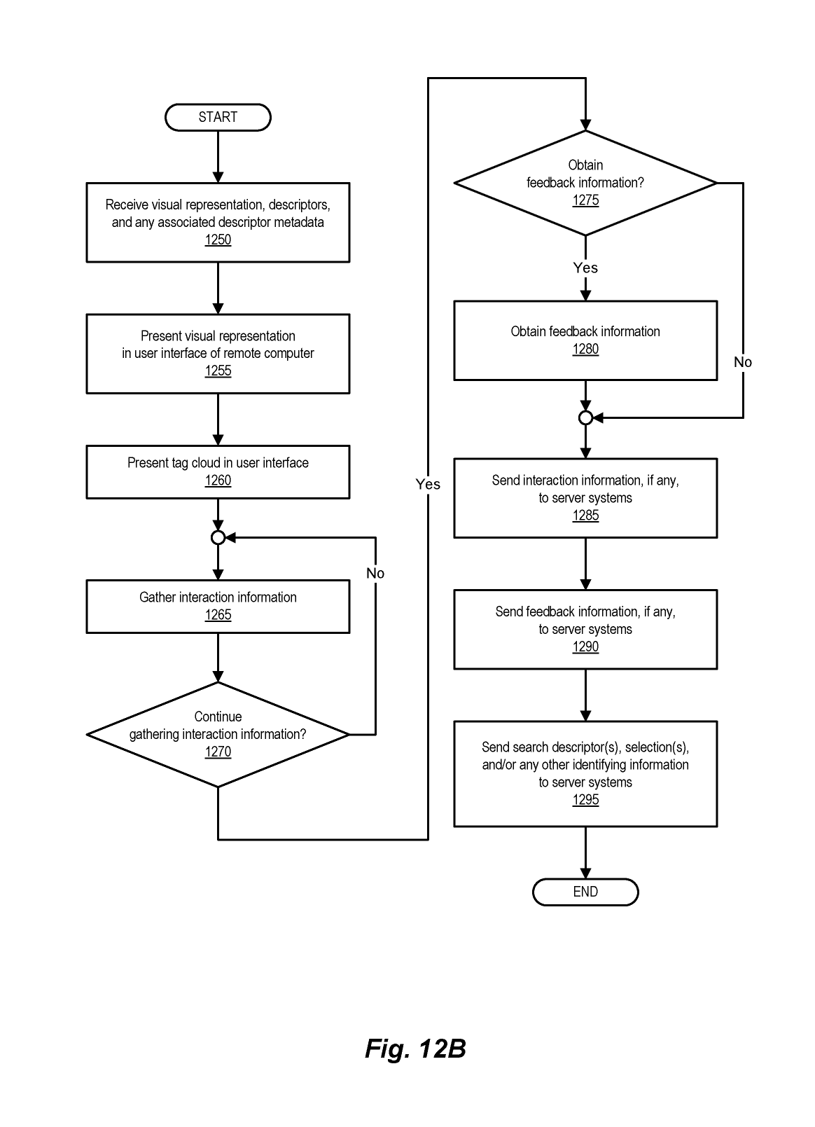

A determination is then made as to whether a request for information regarding a product and/or service has been received (510). As noted, such information is referred to herein as product/service information, and includes one or more products, one or more services, one or more product-service systems, virtual products and/or services, and/or other such offerings. Upon the receipt of a request for product/service information, a server system such as DDB server 425, performs processing of the request for the product/service information using the composite set of descriptors thus generated (520). An example of such a process, as well as its associated sub-processes, is discussed in greater detail in connection with FIGS. 6-10. As noted earlier, such processes include retrieval and provision of product/service information from, for example, content database 435 by content processing module 430. In such a scenario, content processing module 430 receives a request for product/service information (e.g., a visual representation), retrieves the requisite product/service information from content database 435 using information received with the request, and provides the resulting product/service information to descriptor processing module 450. In the case in which an analyst has requested product/service information for review, for example, descriptor processing module 450 then communicates the product/service information thus retrieved to the requesting descriptor input client for display thereby. The converse of such a transaction, in content processing module 430, identifies the requisite product/service information using information received from an end-user, and is described subsequently in connection with FIGS. 11A, 11B, 12A, and 12B.

Once the request for product/service information has been processed, a determination is made as to whether the user at the remote computer (e.g., a customer) has indicated a desire to continue the selection process (530). If the customer has so indicated, the process proceeds to waiting for a request for further product/service information (510). In the alternative, if the customer has indicated that their selection process is complete (530), such as by selecting a given product and/or service, the process proceeds to a determination as to whether any feedback information has been received (step 540). Such feedback information can, in fact, include explicit feedback information (e.g., information received from the customer indicating the customer's estimation of the accuracy, usefulness, efficiency, and other factors with respect to the products and/or services presented to the customer in response to their request for such). Alternatively (or in combination), such feedback information can include information regarding the customer's interactions with the product/service information, the website by which such product/server information is presented, navigation information, and the like. Such feedback information allows server systems such as server systems 402 (and more particularly, DDB server 425) to revise information regarding descriptors (e.g., composite sets of descriptors and/or their corresponding descriptor metadata), in an effort to better meet customer's expectations as to the product/service information provided in response to a request therefor. If such feedback information is received (540), the server systems involved revise the affected composite sets of descriptors and/or descriptor metadata using the feedback information received (550). Once the revisions have been made, or no such revisions are needed/supported, the process returns to awaiting the receipt of a request for product/service information (510). Ultimately, at some point, the process depicted in FIG. 5 can be concluded.

As will be appreciated in light of the present disclosure, descriptor metadata can be any information that is associated with a given descriptor. As such, descriptor metadata can include information such as frequency of occurrence of the descriptor and/or other such weighting information (e.g., author weighting information, customer feedback/interactions, and other such information, either separately or combined), information regarding analyst reputation for the given descriptor (e.g., average reputation of the analysts using the associated descriptor), descriptor characteristics (e.g., to what aspect of the product and/or service does the descriptor relate, such as physical dimensions, physical characteristics such as color, shape, and so on), conceptual impressions (e.g., mood, setting, and so on), and information regarding a descriptor's relationship to other descriptors, among a number of other such alternatives, which are all intended to come within the scope of the present disclosure.

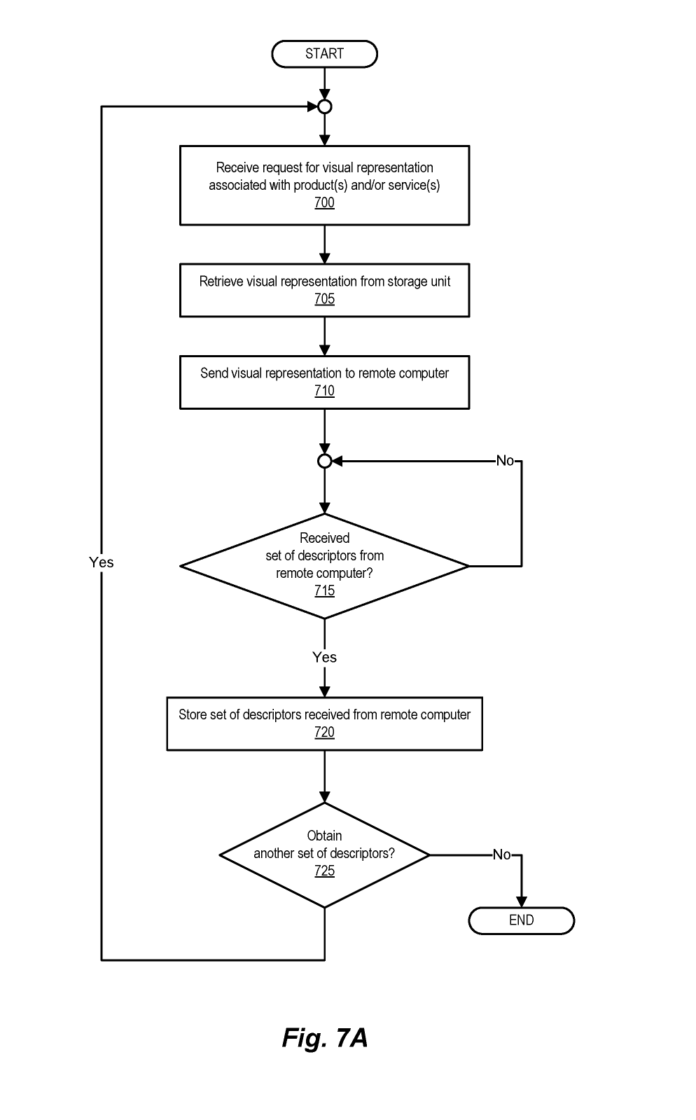

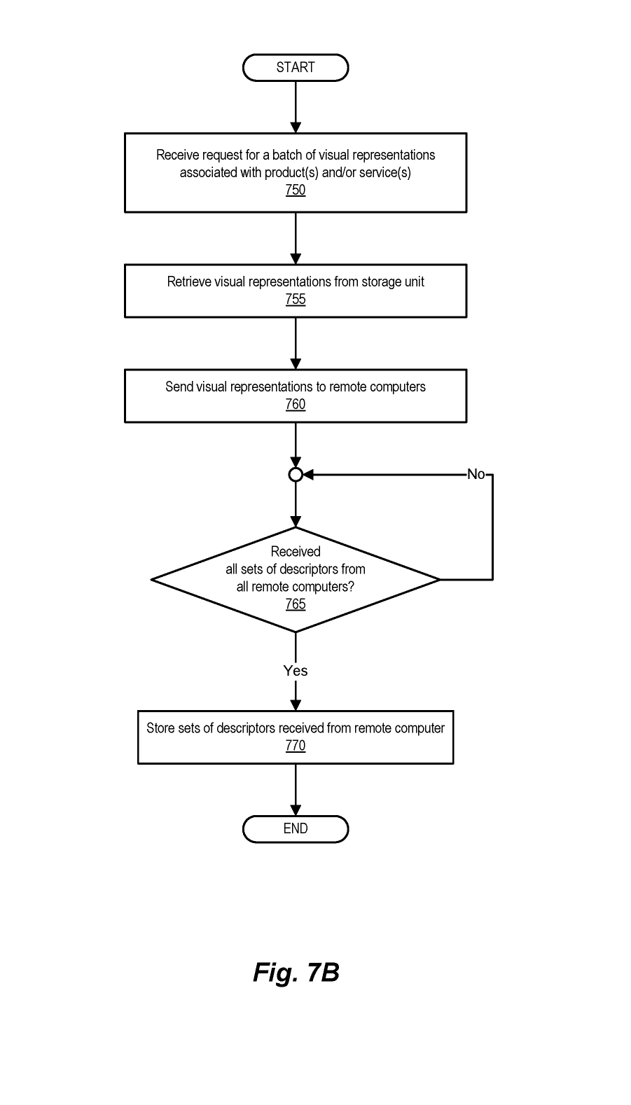

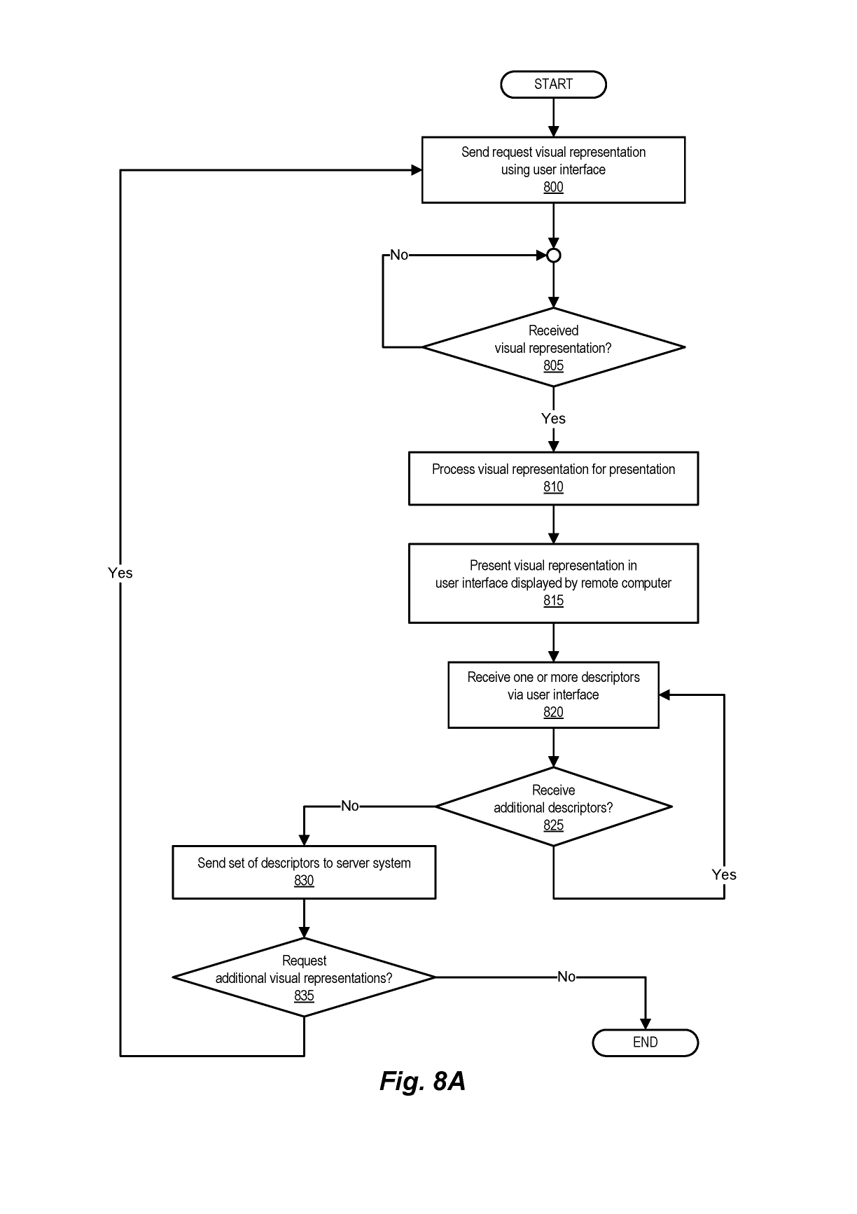

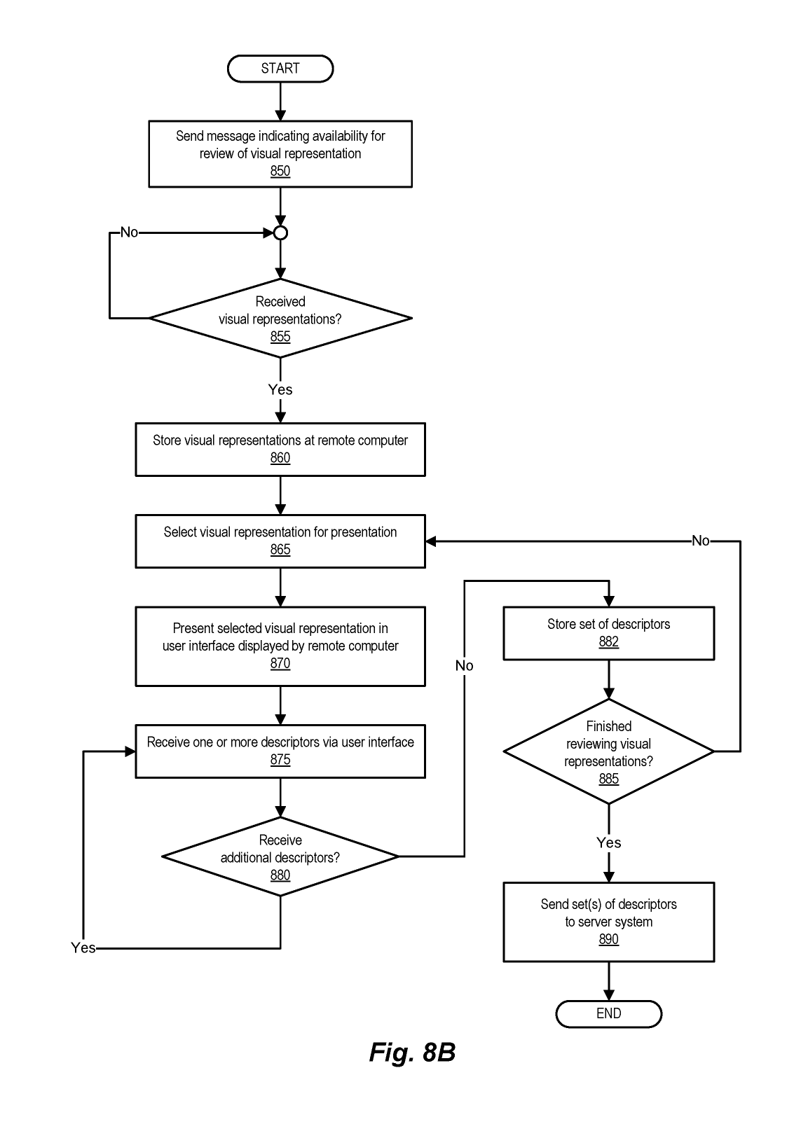

FIG. 6 is a simplified flow diagram illustrating an example of operations performed in generating a composite set of descriptors, according to methods and systems such as those disclosed herein. The process of FIG. 6 thus begins with the obtaining of one or more sets of descriptors (600). An example of the operations performed in obtaining one or more sets of descriptors is discussed in greater detail in connection with FIG. 7A (with regard to operations performed by a server), and FIG. 7B (with regard to the operations performed by a server supporting batch mode processing of such requests), as well as FIGS. 8A (with regard to operations performed by a remote computer) and FIG. 8B (with regard to operations performed by a remote computer supporting batch mode processing), discussed in greater detail below. Once the one or more sets of descriptors have been obtained, a determination is made as to whether any of these sets of descriptors should be processed (610). For any sets of descriptors that require processing, descriptor processing is performed on those sets of descriptors (620). Once any descriptor processing needed has been performed (or if no such descriptor processing is required), a composite set of descriptors is formed from the one or more sets of descriptors (potentially after any descriptor processing is performed) (630). Once the composite set of descriptors has been formed, the composite set of descriptors is stored in a descriptor database such as descriptor database 455 of FIG. 4A. As will be appreciated in light of the present disclosure, then, such processing can be performed, for example, by a descriptor processing module of a DDB server (e.g., descriptor processing module 450 of DDB server 425).

FIG. 7A is a simplified flow diagram illustrating an example of operations performed in obtaining one or more sets of descriptors from the perspective of a server system, according to methods and systems such as those disclosed herein. For example, a server system such as DDB server 425 can obtain one or more sets of descriptors by way of a descriptor processing module such as descriptor processing module 450, which processes the sets of descriptors obtained and stores the processed sets of descriptors in a descriptor database such as descriptor database 455.

The process of obtaining sets of descriptors according to embodiments such as those described herein begins, from the perspective of a server system, with the receipt of a request for a visual representation associated with one or more products and/or services (700). Once the server systems (e.g., DDB server 425) receives a request for such visual representations, the server retrieves one or more of the requested visual representations from an associated storage unit (e.g., descriptor processing module 450 requesting that content processing module 430 retrieve content such as visual representations from content database 435, or directly (if such information is maintained therein) by accessing descriptor database 455) (705).

Once the visual representation(s) (and/or other product/service information) have been retrieved, the visual representation(s) (and/or other product/service information) are sent to a remote computer (710). It will be appreciated that, in light of the present disclosure, multiple ones of such information can, in fact, be sent to multiple remote computers. At this juncture, the server awaits receipt of one or more sets of descriptors from the remote computer (715).

Once the set(s) of descriptors have been received (715), the set(s) of descriptors received are stored by the server (720). Once the set(s) of descriptors have been stored (720), a determination is made as to whether another set of descriptors is to be obtained (725). If additional sets of descriptors are to be obtained, the process iterates, proceeding to the receipt of the next set of descriptors (700). Otherwise, the process concludes. As will be appreciated in light of the present disclosure, the process of FIG. 7A is described in terms of the capture of one or more sets of descriptors by way of the interactions between descriptor input clients operated by one or more analysts and a server system (e.g., the elements of content delivery architecture 200). However, as will be further appreciated, such elements can also be used to revise an existing set of descriptors (e.g., by way of adding or otherwise revising to that existing set of descriptors) and/or revise an existing composite set of descriptors (e.g., by obtaining another set of descriptors and revising the existing composite set of descriptors in light thereof). Further still, the author's impressions can also be collected in a comparable manner, and, in certain embodiments, can be given greater deference than the opinions of analysts (e.g., by employing weighting and/or analyst reputation). These and comparable alternatives are intended to come within the scope of the present disclosure.

FIG. 7B is a simplified flow diagram illustrating another example of operations performed in obtaining multiple sets of descriptors from the perspective of a server system, supporting a batch mode technique, according to methods and systems such as those disclosed herein. In the manner of FIG. 7A, the process depicted in FIG. 7B can employ a server system such as DDB server 425 to obtain one or more sets of descriptors by way of a descriptor processing module such as descriptor processing module 450, which can process the sets of descriptors obtained, and store the processed sets of descriptors in a descriptor database such as descriptor database 455, in batches of sets of descriptors (each having multiple sets of descriptors therein).

The process of obtaining batches of sets of descriptors according to embodiments such as those described herein begins, from the perspective of a server system, with the receipt of a request for a visual representation associated with one or more products and/or services (750). Once a request for such visual representations have been received, the server (e.g., DDB server 425) retrieves multiple visual representations (and/or other product/service information) for the products and/or services in question, as per the request, from an associated storage unit (e.g., descriptor processing module 450 accessing descriptor database 455) (755). Once the information has been retrieved, the information is sent to a remote computer (760). It will be appreciated that, in light of the present disclosure, such information (e.g., multiple visual representations) can, in fact, be sent to multiple remote computers. At this juncture, the server awaits receipt of the requested sets of descriptors from the remote computer(s) (765). Until such a response is received, the process iterates. Once the sets of descriptors have been received (765), the sets of descriptors thus received are stored by the server (770). Once the sets of descriptors have been stored, the process concludes.

FIG. 8A is a simplified flow diagram illustrating an example of operations performed by a remote computer system in providing one or more sets of descriptors to a server system, according to methods and systems such as those disclosed herein. As noted earlier herein, such a remote computer system can be, for example, one of clients 125(1)-(N), GPRS client 140, HTTPS client 150, and/or SMS client 160, as per FIG. 1. Further, such a remote computer system can be configured with various software and hardware modules, such as user interface module 260, presentation module 262, selection input module 264, feedback module 266, and interaction monitoring module 268, as per FIG. 2.

The process of FIG. 8A begins with a request for a visual representation (a visual representation request) being sent from a remote computer, using a user interface (800). Having sent a request for a visual representation, the remote computer awaits receipt of the requested visual representation (805). Once the visual representation has been received, the visual representation is processed by the remote computer for presentation in the user interface (810). Such processing can include format conversion, image processing, cropping, and other such operations, in order to ready the visual representation for presentation in the user interface. Having been processed, the visual representation is then presented in the user interface that is displayed by the remote computer (815). As will be appreciated in light of the present disclosure, presentation of the visual representation in the user interface can include, but is not limited to, the display of photographs, animations, video, graphical information, and other such visual representation of one or more products, services, product-service systems, and/or other such offerings.

At this juncture, one or more descriptors are received via the user interface (820). A determination is periodically made as to whether additional descriptors are to be received (825). Such descriptors can take any form advantageous and appropriate to the application at hand, and may depend on the product, service, product-service system, or other offering that is the subject of characterization. For example, search descriptors can take the form of textual information (including single words, phrases, short passages, and/or any other amount of textual information considered to have relevance to the product/service in question), spoken word, selected visual representations (including images, video clips, and/or the like), other forms of informational recordings, data constructs reflecting selections by the end-user (e.g., selections in an electronic form), and/or any other representational information considered to be related in some fashion to the product(s) and/or service(s) in question. As will therefore be appreciated, the intent of the descriptors described herein is to provide a means by which the relatedness of descriptive information, with respect to the product/service in question, can be collected, maintained, and revised as necessary and appropriate. Further, such descriptors can be objective (e.g., “five feet long”) or subjective (e.g., “a warm shade of red”) in nature.

While additional descriptors are to be received, the process iterates (825 and 820). Once no further descriptors remain, the set of descriptors thus collected is sent to the appropriate server system (830). As noted earlier, a process using descriptor identifiers can be employed to minimize the communications bandwidth consumed, by sending only the descriptor identifiers, and based on that information, sending only the descriptors not already maintained in the descriptor database. At this juncture, a determination is made as to whether additional visual representations are to be requested (835). If additional visual representations are to be requested, the process iterates, proceeding to the point at which a request for another visual representation is sent to the appropriate server system (800). Alternatively, the process concludes. In this fashion, visual representations are requested, received, and presented using the user interface displayed on a display of the remote computer. In so doing, the process illustrated in FIG. 8A provides sets of descriptors to the appropriate server system in a serial fashion.

FIG. 8B is a simplified flow diagram illustrating an example of operations performed by a remote computer system in providing one or more sets of descriptors to a server system, supporting a batch mode technique, according to methods and systems such as those disclosed herein. In a manner similar to the process illustrated in FIG. 8A, the process of FIG. 8B begins with a request for multiple visual representations (a batch visual representation request) being sent from a remote computer, using a user interface (850). Having sent a batch request, the remote computer awaits receipt of the requested visual representations (855).

Once the requested visual representations have been received, the visual representations are stored at the remote computer (860). As will be appreciated in light of the present disclosure, processing of one or more of these visual representations such as that described earlier in connection with FIG. 8A can also be performed in the process depicted in FIG. 8B, and can be performed prior to storage or, alternatively, upon each visual representation's retrieval. As also noted, such processing can include format conversion, storage, cropping, and other such operations, in order to ready the visual representation for presentation in the user interface. The visual representations having been stored, a given one thereof can be selected for presentation in the user interface displayed by the remote computer (865). The selected visual representation is then presented in the user interface displayed by the remote computer (870). As noted, presentation of the visual representation in the user interface can include, but is not limited to, the display of photographs, animations, video, graphical information, and other such visual representations of one or more products, services, product-service systems, and/or other such offerings, as well as other representations, including audible, mechanical, and other such information.

Having presented the visual representation in the user interface, one or more descriptors are received via the user interface (875). As noted above, such descriptors can take any form advantageous and appropriate to the application at hand. Periodically, a determination is made as to whether additional descriptors are to be received (880). So long as additional descriptors are to be received, the process iterates (875 and 880). Once no further descriptors remain to be entered, the set of descriptors thus collected are stored for subsequent transmission to the appropriate server system (882).

At this juncture, a determination is made as to whether additional visual representations remain to be characterized (885). If additional visual representations are to be characterized, the process iterates, proceeding to the point at which another visual representation is selected and retrieved from the remote computer's storage unit (885). Alternatively, if no further visual representations remain for characterization, the sets of descriptors are retrieved and sent to the appropriate server system (890). The process then concludes. In this fashion, multiple visual representations can be requested, received, and presented using the user interface displayed on a display of the remote computer. In so doing, multiple descriptor sets can be presented in a more unified fashion, as might be appropriate, for example, when obtaining characterizations of products and systems making up a product-system offering. As before, ultimately, the process illustrated in FIG. 8B provides sets of descriptors to the appropriate server system, though as a batch of descriptor sets, rather than individually in serial fashion.

In either of the serial or batch approach, it will be further appreciated that descriptors can also be obtained by “seeding” the process through the presentation of a descriptor cloud, examples of which are described subsequently. In the application of a descriptor cloud to seed the collection of descriptors, such a descriptor cloud can be obtained from the author/creator/producer/provider of the product and/or service, or can represent an existing composite set of descriptors for the given product and/or service. An analyst presented with such information can then enter or otherwise indicate descriptors in reaction to the descriptor cloud, or can select ones of the descriptors in the descriptor cloud, for example. Conversely, such a descriptor cloud can be presented to an author/creator/producer/provider of a product and/or service in order to allow the party to better understand the way in which others (e.g., analysts and end-users) see the product and/or service. As will be appreciated, descriptor identifiers can also be put to good use in such applications, allowing only the descriptor identifiers and requisite metadata to be sent, when the corresponding descriptors are already maintained on the remote computer. Further still, a descriptor cloud can be presented to an author/creator/producer/provider at any point in the process of collecting sets of descriptors, forming one or more composite sets of descriptors, and/or after revision by analysts, end-users, and other such entities. In presenting such a descriptor cloud, information in, for example, a descriptor database is “revealed” to the author/creator/producer/provider, by which that party is able to gain insight into others' perceptions regarding the product and/or service.

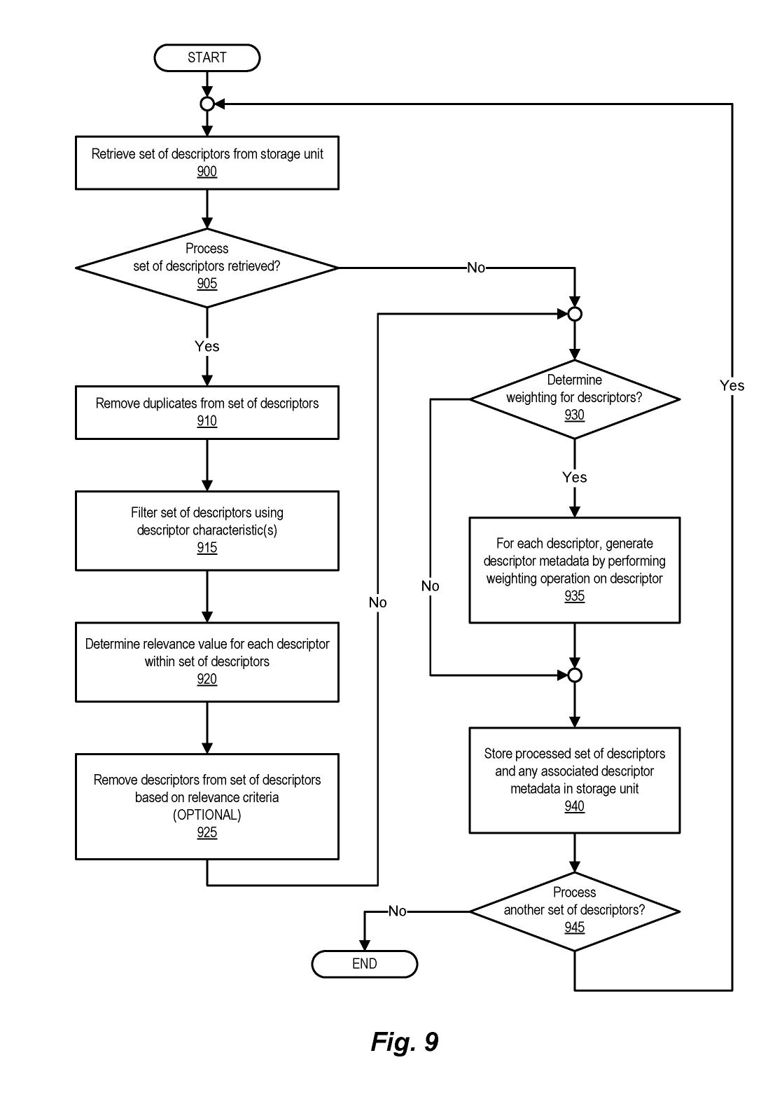

FIG. 9 is a simplified flow diagram illustrating an example of operations performed in processing one or more sets of descriptors, according to methods and systems such as those disclosed herein. A process for processing one or more sets of descriptors, such as that depicted in FIG. 9, begins with the retrieval of a set of descriptors from a storage unit (900). For example, using the components depicted in FIG. 4A, DDB server 425 performs this and other operations described in connection with the process depicted in FIG. 9. With regard to retrieving a set of descriptors, then, descriptor processing module 450 accesses descriptor database 455. In so doing, descriptor processing module 450 is able to retrieve a set of descriptors therefrom. The set of descriptors in question having been retrieved, a determination is made as to whether the given set of descriptors is to be processed (905).

If the set of descriptors is to be processed, any duplicate descriptors in the set of descriptors can, optionally, be removed (910). Next, the set of descriptors can be filtered using one or more descriptor characteristics (915). Descriptor characteristics for use in filtering can be gleaned from historical interactions with other sets of descriptors, preset parameters (e.g., based on, for example, user inputs, machine learning, or other such sources), and the like. As noted, the use of descriptors in methods and systems such as those described herein is intended to convey significantly more than just a literal description of a product and/or service, but rather to comprehend the evocative nature of the product/service information regarding the product, and in so doing, capture impressions, perceptions, and other such subjective aspects evoked by the product and/or service. For example, a descriptor for an image of a fire in a living room fireplace might evoke “warmth,” “family,” “home,” an/ or other such subjective concepts. By using methods and systems such as those described herein, such information, though difficult or impossible to quantify, can be collected from some number of analysts, and used to more accurately and efficiently present alternatives to an end-user (e.g., a customer) in the process of selecting an offering, for example.

Relevance values for each of the descriptors within the set of descriptors can also be determined at this juncture (920). As used herein, the determination of a given descriptor's relevance value within the given set of descriptors can be determined relative to other descriptors in that set of descriptors. As such, in this regard, the use of “within” indicates the relevance of the given descriptor to the product/service in question as compared to other descriptors in the set of descriptors (and so, with respect to those descriptors). Alternatively, as discussed elsewhere, such relevance values can be determined with regard to an absolute scale. Optionally, descriptors can be removed from the set of descriptors based on their corresponding relevance values, using one or more relevance criteria (925).

If the retrieved set of descriptors is not to be processed (or once such processing has been completed), a determination is made as to whether the descriptors of the set of descriptors are to have weighting operations performed thereon (930). If the weighting of the descriptors in the set of descriptors is to be determined, for each such descriptor, descriptor metadata is generated by performing one or more weighting operations on the given descriptor (935). Such weighting operations, as noted elsewhere herein, can take a variety of factors into consideration, including the reputation of the analyst contributing to the list of descriptors, the importance of each descriptor to the entity offering the product(s) and/or service(s), historical information regarding the given customer (e.g., preferences, prior purchases, and so on), and other such factors. As used herein, the term “weighting” can also comprehend the weight to be accorded the descriptor based on an absolute scale, a relative scale (e.g., as between descriptors in a given set of descriptors or a composite set of descriptors), or the like. Moreover, such weighting allows for the capture and representation of a given product's and/or service's expression of a given degree of a characteristic. For example, if the descriptor indicated “blue,” descriptor metadata associated with a descriptor (for such “blue-ness”) could range from “not very blue” to “extremely blue” - a subjective characteristic, to be sure, but one that can be subject to information indicating the degree thereof. Methods and systems such as those described herein can not only capture such information, but allow for such characteristics to be the subject of searching.

Once descriptor weighting operations have been performed (or, in the alternative, no such operations are to be performed), the processed set of descriptors, as well as any associated descriptor metadata, are stored in the appropriate storage unit (940). As will be appreciated in light of the present disclosure, search processing and storage can be effected by way of descriptor processing module 450 and descriptor database 455. A determination is then made as to whether another set of descriptors is to be processed (945).

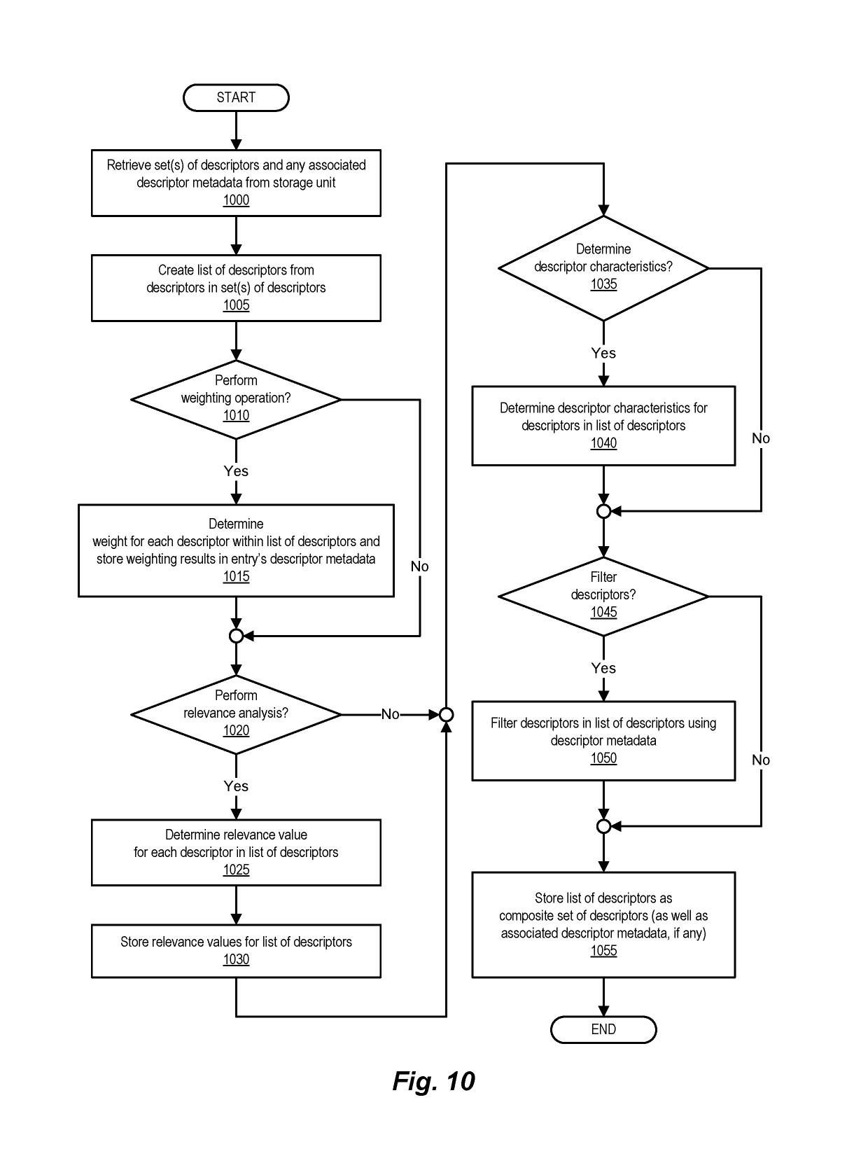

FIG. 10 is a simplified flow diagram illustrating an example of operations performed in forming a composite set of descriptors, according to methods and systems such as those disclosed herein. Having collected various sets of descriptors, as well as any associated descriptor metadata, the server systems are then able to form one or more composite sets of descriptors. The example of forming a composite set of descriptors depicted in FIG. 10 begins with the retrieval of the set(s) of descriptors and their associated descriptor metadata from the appropriate storage unit (1000). From the set(s) of descriptors retrieved, the descriptors are aggregated into a list of descriptors (1005). Such a list of descriptors, in certain embodiments, includes entries for only unique instances of descriptors. In being implemented in this fashion, such a list of descriptors is able to be used in forming a composite set of descriptors that is capable of representing the meaningfulness of each descriptor. Such meaningfulness can be represented by way of characteristics such as frequency of occurrence, perceived relatedness to the product/service in question, importance to the party offering the product/service, the reputation of the analyst who provided the descriptor, and/or other such characteristics.

In this regard, then, a determination is made as to whether one or more weighting operations are to be performed on the descriptors represented by entries in the list of descriptors (1010). If such weighting operations are to be performed, a determination is made as to the weight to be assigned to each descriptor within the list of descriptors, and the results of such weighting operations stored in the descriptor metadata for each affected descriptor's corresponding entry in the list of descriptors (1015). As noted, descriptor weighting represents the importance placed on each descriptor in the list of descriptors. The descriptor weighting for a given descriptor can be based on the importance of that descriptor in the opinion of one or more of the analysts (e.g., one or more of the analysts can provide or be solicited for the importance of one or more of the descriptors), by the author (or producer, manufacturer, or comparable entity), by customers, by authors in the given market segment, by the entity operating a system such as those described herein, and/or other such sources.

For example, the importance attributed to a given descriptor can be driven by the fact that, for certain products, physical dimensions are more important than subjective attributes (e.g., in the case of a microwave oven, the fact that the oven is a (desirable) “warm” shade of red is irrelevant if the oven's physical dimensions are too large for the oven to fit in the available space in the customer's kitchen). Such descriptor weighting can represent such weighting as between descriptors in the list of descriptors (e.g., one descriptor weighted more heavily than another) and/or on an absolute scale, though the representation of such relationships need not be the case. Further, such descriptor weighting can include not only information received from analysts, but also from the author/creator/manufacturer of such products and/or services and customers involved in perusing or acquiring such products and/or services. Such weighting can, for example, use each descriptor's frequency of occurrence in the retrieved set(s) of descriptors. Further, descriptors that are more objective (e.g., the objectively descriptive “one foot in diameter,” in the instance of a ball) and more subjective (“a warm shade of red,” in that instance) can be weighted differently, thereby allowing methods and systems such as those described herein to discern between such descriptions (as well as to allow for adjustment in recommendations by way of user input (e.g., the importance of literal descriptions versus evocative impressions)).

Having performed the aforementioned weighting operations (or, alternatively, having not), a determination is then made as to whether relevance analysis is to be performed (1020). If relevance analysis is to be performed, a determination is made, for each descriptor in the list of descriptors, as to the relevance value for the given descriptor in the list of descriptors (1025). Such relevance values can be determined by frequency of occurrence in responses from analysts, ratings by one or more reviewers, feedback from end-users, and/or other such sources. Further, relevance values can represent the relevance of the given descriptor on an absolute scale or a relative scale (e.g., with respect to the other descriptors in the list of descriptors). In contrast to the aforementioned descriptor weighting operations, such relevance analysis captures the relevance of each descriptor with respect to the product and/or service in question (i.e., a measure of how related the given descriptor is viewed as being to the given product and/or service, in the opinion of the analyst(s) and/or other entities (such as those described earlier)). Once determined, the relevance values are then stored (e.g., in the descriptor metadata for each descriptor) (1030).

Next, a determination is made as to descriptor characteristics for the descriptors in the list of descriptors (1035). If such a determination is to be made, descriptive characteristics are determined for each descriptor in the list of descriptors (1040). Search descriptor characteristics can include a rating of the literal versus impressionistic nature of the descriptors, the type of descriptor (e.g., size, color, and other such physical characteristics), how recently the descriptor was provided, the source of the descriptor (provided as part of the analysis process, and which can be revised as part of the feedback process, as noted), and/or other such metrics. Further, in providing for the processing of descriptors using descriptive characteristics, descriptors can be grouped based on one or more such characteristics. Further still, the descriptors, particularly after having been processed thusly, can be used in the generation and display of descriptor clouds for use by end-users and others, in a variety of situations. For example, using a greeting card as an example, having created the greeting card, the author would like to determine customers' reactions to the card, their impressions, what these customers think about the greeting card, and what the customers think the greeting card is about. Each descriptor in the descriptor cloud can also be linked to all other products or services exhibiting the same or similar descriptor. The link could be a “hard” link to a predefined collection or it could trigger a search using the descriptor as the search term.

By presenting the author with a descriptor cloud, the author can gain insight into these and other intangibles regarding their creation. As will be appreciated, such a descriptor cloud can also be presented to an end-user, in order to present the end-user with a weighted (e.g., as represented by the size of the font used to present a word, if the descriptor is amenable to such display), indicating the “meaningfulness” of each such descriptor. This aspect is described in further detail in connection with FIG. 12B, below.

The descriptors in the list of descriptors can then be filtered, if desired or needed (1045). If descriptor filtering is to be performed, descriptor metadata for each of the descriptors in the list of descriptors is used to filter those descriptors, for example, in a manner such as that described earlier in connection with FIG. 9 (1050). Such filtering can include descriptors (e.g., use only textual descriptors), descriptor metadata (e.g., use only descriptors occurring with a frequency above some value, rank based on relevance, and so on), and/or other such characteristics. For example, such processing can rank the descriptors in the list of descriptors based on an appropriate ranking metric (e.g., perceived importance, frequency of occurrence, and/or the like), and, by ordering the descriptors in a rank order (e.g., least to greatest), so produce a ranked list of descriptors. Once the aforementioned descriptor processing operations have, if appropriate, been performed, the now-processed list of descriptors (including any associated descriptor metadata) is stored as the composite set of descriptors (1055). As will be appreciated in light of the present disclosure, such processing can, for example, augment the descriptors in the composite set of descriptors using synonyms of textual information, image searching and categorizing, and other such methods in order to enrich the information encompassed by the composite set of descriptors. The process then concludes.

As will be appreciated in light of the present disclosure, methods and systems such as those disclosed herein provide for the generation and weighting of descriptors stored, for example, in a descriptor database. Once a composite set of descriptors is thus generated, such methods and systems support searching for one or more products and/or services based on such descriptors. Further, methods and systems such as those disclosed herein can be used to take raw information (e.g., one or more sets of descriptors or comparable information), and by way of processing such as that described herein, including the aggregating and forming of composite sets of descriptors therefrom, can determine the relevance of various descriptors with respect to the given product and/or service (regardless of its general nature (e.g., whether physical, virtual, or a combination thereof), and in so doing, provide the ability to search for a desired one or more of such products and/or services using such descriptors.

FIG. 11A is a simplified flow diagram illustrating an example of operations performed in executing a search for product and/or service information from the perspective of a server system, according to methods and systems such as those disclosed herein. As will be appreciated in light of the present disclosure, end-users of a content delivery architecture such as that depicted in FIGS. 2 and 4 (e.g., customers of a marketplace or enterprise, which offers products and/or services via a website, such as might be presented by a web server (web server 232)) are able to access such a website via a network using a remote computer system (e.g., user clients 220(1)-(N)). In certain embodiments, for example, in response to a customer navigating to the enterprise's website, the customer is able to input one or more search descriptors, in an attempt to identify a product and/or service that best meets their needs, preferences, tastes, desires, sensibilities, and so on, in as accurate and efficient manner as possible (from the perspective of both customer interactions and computer resources). In this regard, such a remote computer system can be, for example, one of clients 125(1)-(N), GPRS client 140, HTTPS client 150, and/or SMS client 160, as per FIG. 1. Further, such a remote computer system can be configured with various software and hardware modules, such as user interface module 260, presentation module 262, selection input module 264, a feedback module 266, and interaction monitoring module 268, as per FIG. 2.

The process depicted in FIG. 11A thus begins with the receipt of one or more such search descriptors from the remote computer at, for example, a content server such as content server 420 (by way of, e.g., network 240 and web server 232) (1100). Having received the one or more search descriptors, a descriptor processing module searches a descriptor database using the one or more search descriptors received (1110). Using the architecture depicted as server systems architecture 400 in FIG. 4A as an example, after the search descriptors are received from a remote computer via network 405 and web server 410, content server 420 invokes content processing module 430 to access content database 435 by sending a search request to DDB server 425 (and more particularly, descriptor processing module 450, which accesses descriptor database 455)). In turn, descriptor processing module 450 returns identifying information corresponding to the descriptors to content processing module 430 of content server 420, facilitating the retrieval of visual representations and other such product/service information. Content processing module 430 can then use this information to access product/service information maintained in content database 435.

Such operations are illustrated in the process of FIG. 11A, in the following manner In searching the descriptor database, descriptors and associated descriptor metadata identified by the search are retrieved (1120). At this juncture, it will be appreciated that, in light of the present disclosure, weighting can also be performed as part of using descriptors in identifying products and/or services (e.g., the use of weighting in identifying product/service information using descriptors processed based on weighting and/or relevance). For example, a table of weights and relevancy scores can be maintained, such that a different set of weights and/or relevancy scores are used depending on some characteristics of the user or the circumstances of use. For example, different weights can be applied to the same product and/or service, depending on any number of considerations (e.g., factors such as the gender of the customer, the time of year when the search is conducted, the location from which the search is conducted, and/or other such factors that might influence the product(s) and/or service(s) thus identified). Further in this regard, then, such weightings and relevance values can be used to process descriptors provided by and/or selected by a customer, in a dynamic, real-time manner (e.g., without the customer perceiving a delay). Conversely, the descriptors in a given composite set of descriptors can be stored in a “raw” form (e.g., without having been subjected to weighting and relevance analysis), with such weighting and relevance analysis being performed on those descriptors upon the retrieval of the composite set of descriptors. As a result, the descriptors of the composite set of descriptors can be weighted and their relevance determined, for example, in light of factors such as those just described, and in so doing, create a processed (e.g., weighted) composite set of descriptors dynamically (“on the fly,” as it were).

Next, information regarding products and/or services (product/service information) is retrieved using the descriptors and any associated descriptor metadata identified and retrieved as a result of the aforementioned search (1130). Such product/service information represents, essentially, the server systems' best estimation of the product(s) and/or service(s) desired by the customer submitting the search. The content server then sends the product/service information retrieved (possibly accompanied by related visual representations, audio information, metadata, and/or other available information that may prove helpful to the customer in making a decision as to the product/service (offering) to purchase) to the remote computer (1140). The process then concludes.

FIG. 11B is a simplified flow diagram illustrating another example of operations performed in executing a search for product and/or service information from the perspective of a remote computer, according to methods and systems such as those disclosed herein. As noted, end-users of a content delivery architecture such as that depicted in FIGS. 2 and 4 (e.g., customers of an enterprise offering products and/or services via a website, such as might be presented by a web server) are able to access such a website via a network using a remote computer system. As will be appreciated, then, such remote computers can take the form of one or more user clients such as user clients 220(1)-(N) of FIG. 2. To that end, a presentation module of such a user client presents web pages to the end-user in a user interface generated by the remote computer's user interface module, for example. Using the user interface, the customer is able to present a request for information regarding a desired product and/or service by inputting one or more search descriptors, and, in response, receive information regarding the desired product and/or service and/or suggestions as to other, related products and/or services.

The process depicted in FIG. 11B thus begins with the end-user (e.g., customer) providing one or more search descriptors (1150). Using user client 220(1) as an example, user interface module 260, having presented the user interface, receives the one or more search descriptors provided by the customer, for example. User interface module 260 interacts with selection input module 264 in order to communicate the one or more search descriptors to the server system (1160). As will be appreciated in light of the present disclosure, selection input module 264 can be configured to present selection alternatives to the end-user via, for example, presentation module 262 and user inter module 260. During the end-user's interactions with the user interface (and so, the website), such interactions can be monitored and recorded by, for example, the interaction monitoring module 268. Similarly, feedback from the end-user can be solicited and recorded by, for example, a feedback module such as feedback module 266.

The one or more search descriptors and/or other information having been sent to the server system, the remote computer system awaits receipt of the resulting product/service information (1170). Upon receipt of this product/service information, the product/service information (including any visual representations, descriptor information, descriptor metadata, and/or other such information) is presented to the end-user in the user interface by way of the presentation module and user interface module (1180). A determination is then made as to whether the end-user has finished the product/service selection process (1190). If the end-user continues the selection process, the process iterates, proceeding to the point at which search descriptors and any related information are received via the user interface (1150). Alternatively, the process concludes. As will be appreciated in light of the present disclosure, it is possible that the search response from the server system (e.g., the content server) indicates that a product and/or service meeting the search criteria (e.g., search descriptors) set forth in the search request. In such a case, additional or alternative search criteria can be solicited from the end-user. Further in this regard, one or more of the search criteria (e.g., search descriptors) may not be sufficiently definitive for the content server to perform a search. In such a situation, the content server can indicate to the remote computer (and so, the end-user) that the search descriptor is, for example, ambiguous and request clarification. In fact, certain embodiments can provide an end-user with one or more suggestions for disambiguation of the search descriptor in question, in order to assist the end-user in formulating an acceptable search.

FIG. 12A is a simplified flow diagram illustrating an example of operations performed in conducting a search for product and/or service information from the perspective of a server system, where the process supports the use of a descriptor cloud and feedback information, according to methods and systems such as those disclosed herein. The process depicted in FIG. 12A is similar to that depicted in FIG. 11A. However, in the process of FIG. 12A, functionality is provided that supports the collection and maintenance of descriptor cloud information, interaction information, feedback information, and the like, as part of and/or during interaction by customers with the website, for example. Such an assumption is made in order to permit description of these operations with respect to the process depicted in FIG. 12A. It will be appreciated in light of the present disclosure, however, separate processes can be executed (at both the remote computer and the content server) in order to provide for such functionality. In such a case, the flow of the requisite information would occur in parallel with the communications described herein. Further, such interactions can include, for example, an end-user's navigation through a website, selection of items in forms presented in the website, access to various functions, and the like.

As before, then, one or more descriptors and/or other identifying information are received from the remote computer by the content server (1200). In a manner similar to that described previously, descriptors and any associated descriptor metadata are identified using the search descriptors and/or other identifying information (1205). In a process that supports the use of descriptor clouds, feedback information, interaction information, and the like, such as that depicted in FIG. 12A, determinations are made as to whether descriptors, descriptor metadata, relationships between descriptors and content information, and other such informational dimensions are to be modified based on such information. In so doing, methods and systems such as those described herein are able to describe an n-dimensional description space, where informational dimensions can include can include “dimensions” such as descriptors (e.g., physical characteristics, impressions, and other such descriptors), meta-information (e.g., relationships between descriptors, potential descriptors, and the like), and other such information. In the process illustrated in FIG. 12A, such information is assumed to accompany search descriptors and other identifying information, reflecting the aggregation of such information collected since the last such request was received.

Thus, in the process depicted in FIG. 12A, a determination is made as to whether any feedback information has been received (1210). If feedback information was received with the search descriptors/selection information from the remote computer, content information and descriptor relationships and other relevant data can be revised and/or otherwise updated using the feedback information received (1215). Once the requisite processing based on feedback information has been performed (or where such processing is not performed, as a result of a lack of feedback information, for example) a determination is made as to whether interaction information has been received (1220). If interaction information has been received, contact information, descriptor relationships, and other data can be revised and/or otherwise updated using the interaction information that's received open parenthesis 1225). If no such interaction information is received (or upon the completion of such processing), the requisite visual representations and/or associated product/service information is retrieved by the content server (1230). Having retrieved the relevant visual representations and/or associated product/service information, the content server then sends this information to the remote computer for presentation in the remote computer's user interface (1235). The process then concludes.

FIG. 12B is a simplified flow diagram illustrating an example of operations performed in conducting a search for product/service information from the perspective of a remote computer, where the process supports the use of a descriptor cloud and feedback information, according to methods and systems such as those disclosed herein. The process depicted in FIG. 12B is similar to that depicted in FIG. 11B. However, in a manner similar to that of FIG. 12A, functionality is provided that supports the collection and maintenance of descriptor cloud information, interaction information, feedback information, and the like, as part of and/or during a customer's interaction with the website, for example.

In the manner noted previously, and as will be apparent in light of the present disclosure, the processes described in connection with FIG. 12B are presented in a manner that assumes the provision of such information with request sent from the remote computer to the server systems. However, as noted search processes can be executed in parallel, and so, can be executed separately from the communications between the remote computer system and the content server. As will also be appreciated, while the aggregation of interaction information is depicted as occurring during a customer's interaction with the website via the remote computer's user interface, followed by feedback information being obtained, such need not be the case. Again, these operations and their arrangement have been chosen simply to illustrate the relevant concepts, and thus, other operations and arrangements will be apparent to one of skill in the art in light of the present disclosure.

In order to effect the foregoing, the process of FIG. 12B begins with the receipt of one or more visual representations, descriptors, and/or associated descriptor metadata, in the manner described earlier (1250). The visual representation(s) and associated information are then presented in the user interface displayed by the remote computer on its display (1255). In addition, the descriptors and any associated descriptor metadata can be used to present one or more visual structures (e.g., a descriptor cloud or the like) in the user interface, in order to allow the customer to more intuitively navigate the relevant product/service information (1260). As noted earlier, such a descriptor cloud can also be presented to an end-user, in order to present the end-user with a selection of descriptors from which to choose. In certain embodiments, the presentation of descriptors in a descriptor cloud can reflect the relevance, weighting, or other characteristics of the descriptors presented (e.g., by way of the font size used to present each descriptor, if the descriptor(s) are amenable to such display), indicating the “meaningfulness” or “importance” of each such descriptor, as determined by processes such as those described herein, and as described in further detail in connection with FIG. 12B, below, for example.

As the customer interacts with the information presented, systems on the remote computer can monitor these interactions (such web page navigation, selections within web pages, and the like), gathering and recording such interaction information for use in revising information stored in the databases of the content server and descriptor database server. These operations are illustrated in FIG. 12B by way of gathering interaction information (1265) and determinations made as to whether such collection operations should be continued (1270). Such operations can be performed, for example, by an interaction monitoring module such as interaction monitoring module 268.

Such collection operations are continued until, for example, customer feedback is to be obtained, searching information is to be sent, or upon the occurrence of some other such event. In this vein, a determination is then made as to whether feedback information is to be obtained, upon the cessation of the aforementioned gathering operations (1275). If feedback information is to be obtained, a feedback module such as feedback module 266 presents the customer with a form or other such displayed structure via a presentation module and a user interface module (1280). Once the customer has completed this informational request (or such a request is not made), any interaction information collected during the customer's interaction with the user interface is sent to the server systems (1285). Next, any feedback information collected is sent to the server systems (1290). Lastly, the one or more search descriptors, selections, and/or any other identifying information are sent to the server systems from the remote computer system (1295).

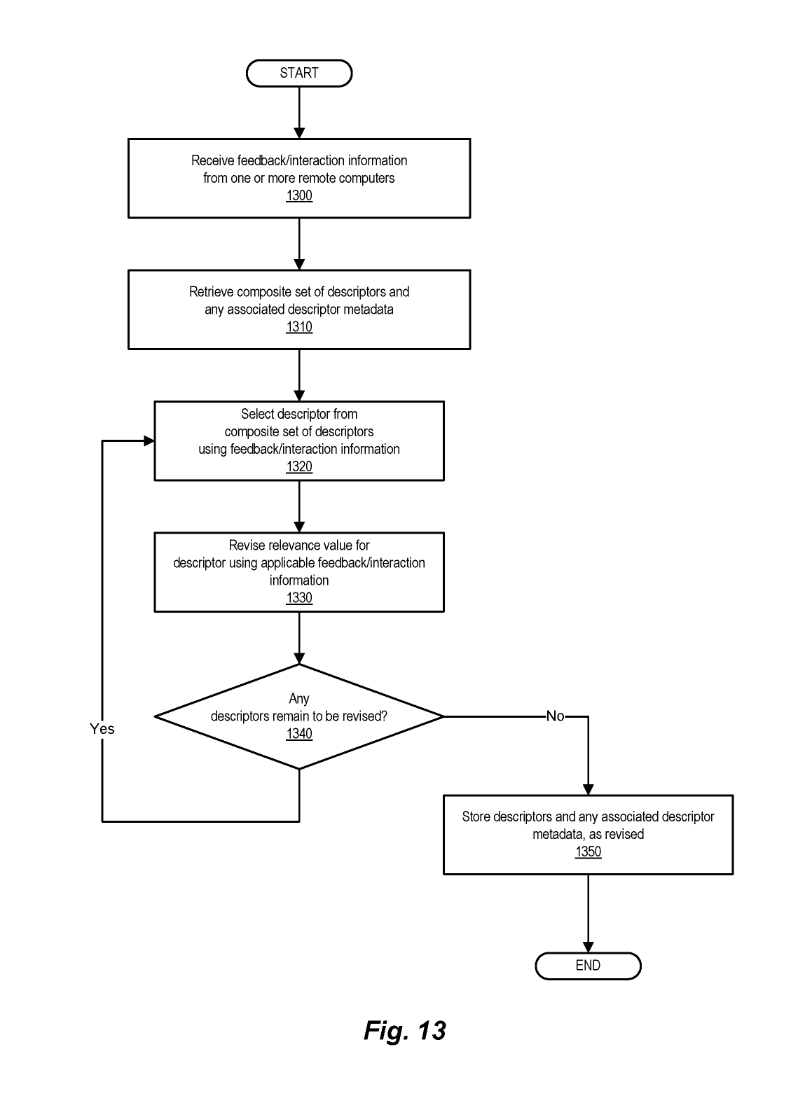

FIG. 13 is a simplified flow diagram illustrating an example of operations performed in revising relevance values of descriptors, according to methods and systems such as those disclosed herein. As noted with respect to the processes illustrated in FIGS. 12A and 12B, information can be gleaned from the interactions between the customer and the website in question, as well as solicited directly from customers, and used to revise or otherwise update descriptors, descriptor metadata, their relationships to various of their respective visual representations, and so on. The process depicted in FIG. 13 provides an example of the use of customer feedback information in performing such revisions, and in so doing, provides a mechanism for such interactions and feedback to influence relevance information maintained by server systems such as the content server and descriptor database server of FIG. 2.

In the example depicted in FIG. 13, the process begins with the receipt of the aforementioned feedback/interaction information from one or more remote computers (1300). Once this information has been received, a composite set of descriptors (or one or more individual descriptors), including any associated descriptor metadata, is retrieved for revision (1310). In the embodiment depicted, a descriptor is selected from the composite set of descriptors using the feedback information received (1320). One or more relevance values for the descriptor thus selected are then revised using the feedback/interaction information applicable to that descriptor (1330). A determination is then made as to whether, based on the feedback/interaction information received, further descriptors remain to be revised (1340). If additional descriptors are to be revised, the process returns to the selection of the next descriptor from the composite set of descriptors (1320). Once the affected descriptors in their respective metadata have been revised, the process proceeds to storing the descriptors and their associated metadata (1350). The process then concludes. Again, as noted, the present example is given in regard to feedback/interaction information and its effect on relevance values for one or more descriptors. Such a process is merely exemplary, and the aforementioned alternatives, as well as pictures, will be apparent in light of the present disclosure, and are intended to come within the scope thereof.

### An Example Computing and Network Environment

As shown above, the systems described herein can be implemented using a variety of computer systems and networks. Examples of such computing and network environments are described below with reference to FIGS. 14 and 15.

FIG. 14 depicts a block diagram of a computer system 1410 suitable for implementing aspects of the systems described herein, and the like. Computer system 1410 includes a bus 1412 which interconnects major subsystems of computer system 1410, such as a central processor 1414, a system memory 1417 (typically RAM, but which may also include ROM, flash RAM, or the like), an input/output controller 1418, an external audio device, such as a speaker system 1420 via an audio output interface 1422, an external device, such as a display screen 1424 via display adapter 1426, serial ports 1428 and 1430, a keyboard 1432 (interfaced with a keyboard controller 1433), a storage interface 1434, a floppy disk drive 1437 operative to receive a floppy disk 1438, a host bus adapter (HBA) interface card 1435A operative to connect with a Fibre Channel network 1490, a host bus adapter (HBA) interface card 1435B operative to connect to a SCSI bus 1439, and an optical disk drive 1440 operative to receive an optical disk 1442. Also included are a mouse 1446 (or other point-and-click device, coupled to bus 1412 via serial port 1428), a modem 1447 (coupled to bus 1412 via serial port 1430), and a network interface 1448 (coupled directly to bus 1412).

Bus 1412 allows data communication between central processor 1414 and system memory 1417, which may include read-only memory (ROM) or flash memory (neither shown), and random access memory (RAM) (not shown), as previously noted. RAM is generally the main memory into which the operating system and application programs are loaded. The ROM or flash memory can contain, among other code, the Basic Input-Output System (BIOS) which controls basic hardware operation such as the interaction with peripheral components. Applications resident with computer system 1410 are generally stored on and accessed from a computer-readable storage medium, such as a hard disk drive (e.g., fixed disk 1444), an optical drive (e.g., optical drive 1440), a floppy disk unit 1437, or other computer-readable storage medium.

Storage interface 1434, as with the other storage interfaces of computer system 1410, can connect to a standard computer-readable medium for storage and/or retrieval of information, such as a fixed disk drive 1444. Fixed disk drive 1444 may be a part of computer system 1410 or may be separate and accessed through other interface systems. Modem 1447 may provide a direct connection to a remote server via a telephone link or to the Internet via an internet service provider (ISP). Network interface 1448 may provide a direct connection to a remote server via a direct network link to the Internet via a POP (point of presence). Network interface 1448 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 14 need not be present to practice the systems described herein. The devices and subsystems can be interconnected in different ways from that shown in FIG. 14. The operation of a computer system such as that shown in FIG. 14 is readily known in the art and is not discussed in detail in this application. Code to implement the modules of the systems described herein can be stored in computer-readable storage media such as one or more of system memory 1417, fixed disk 1444, optical disk 1442, or floppy disk 1438. The operating system provided on computer system 1410 may be MS-WINDOWS®, UNIX®, Linux®, or other operating system.

Further, and as will be appreciated in light of the present disclosure, each of the operations described herein may be executed by a module (e.g., a software module) or a portion of a module, or a computer system user. Thus, the above-described method, the operations thereof and modules therefor may be executed on a computer system configured to execute the operations of the method and/or may be executed from computer-readable storage media. The method may be embodied in a machine-readable and/or computer-readable storage medium for configuring a computer system to execute the method. Thus, the software modules may be stored within and/or transmitted to a computer system memory to configure the computer system to perform the functions of the module.

The software modules described herein may be received by a computer system, for example, from computer-readable storage media. Such computer readable storage media may be permanently, removably or remotely coupled to the computer system. Computer-readable storage media may non-exclusively include, for example, any number of the following: magnetic storage media (including disk and tape storage media); optical storage media such as compact disk media (e.g., CD ROM, CD R, etc.) and digital video disk storage media; nonvolatile memory storage memory including semiconductor-based memory units such as FLASH memory, EEPROM, EPROM, ROM or application specific integrated circuits; and volatile storage media (including registers, buffers or caches, main memory, RAM, etc.). In a UNIX-based embodiment, the software modules may be embodied in a file, which may be a device, a terminal, a local or remote file, a socket, or other such element. Other new and various types of computer-readable storage media may also be used to store the software modules discussed herein.

Many other devices or subsystems (not shown) may be connected in a similar manner (e.g., bar code readers, document scanners, digital cameras and so on). Conversely, it is not necessary for all of the devices shown in FIG. 14 to be present to practice the present invention. The devices and subsystems may be interconnected in different ways from that shown in FIG. 14. The operation of a computer system such as that shown in FIG. 14 is readily known in the art and is not discussed in detail in this application. Code to implement the present invention may be stored in computer-readable storage media such as one or more of system memory 1416, fixed disk 1444, CD-ROM 1442, or floppy disk 1438. Additionally, computer system 1410 may be any kind of computing device, and so includes personal data assistants (PDAs), network appliance, X-window terminal or other such computing device. Computer system 1410 also supports a number of Internet access tools, including, for example, an HTTP-compliant web browser having a JavaScript interpreter, such as Netscape Navigator®, Microsoft Internet Explorer® and the like.

Moreover, regarding the signals described herein, those skilled in the art will recognize that a signal may be directly transmitted from a first block to a second block, or a signal may be modified (e.g., amplified, attenuated, delayed, latched, buffered, inverted, filtered or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

FIG. 15 is a block diagram depicting a network architecture 1500 in which client systems 1510, 1520 and 1530, as well as storage servers 1540A and 1540B (any of which can be implemented using computer system 1510), are coupled to a network 1550. Storage server 1540A is further depicted as having storage devices 1560A(1)-(N) directly attached, and storage server 1540B is depicted with storage devices 1560B(1)-(N) directly attached. Storage servers 1540A and 1540B are also connected to a SAN fabric 1570, although connection to a storage area network is not required for operation. SAN fabric 1570 supports access to storage devices 1580(1)-(N) by storage servers 1540A and 1540B, and so by client systems 1510, 1520 and 1530 via network 1550. Intelligent storage array 1590 is also shown as an example of a specific storage device accessible via SAN fabric 1570.

With reference to computer system 1410, modem 1447, network interface 1448 or some other method can be used to provide connectivity from each of client computer systems 1510, 1520 and 1530 to network 1550. Client systems 1510, 1520 and 1530 are able to access information on storage server 1540A or 1540B using, for example, a web browser or other client software (not shown). Such a client allows client systems 1510, 1520 and 1530 to access data hosted by storage server 1540A or 1540B or one of storage devices 1560A(1)-(N), 1560B(1)-(N), 1580(1)-(N) or intelligent storage array 1590. FIG. 18 depicts the use of a network such as the Internet for exchanging data, but the systems described herein are not limited to the Internet or any particular network-based environment.

The foregoing described embodiments wherein the different components are contained within different other components (e.g., the various elements shown as components of computer system 1410, discussed subsequently). It is to be understood that such depicted architectures are merely examples, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality.

### Other Embodiments

The systems described herein are well adapted to attain the advantages mentioned as well as others inherent therein. While such systems have been depicted, described, and are defined by reference to particular descriptions, such references do not imply a limitation on the claims, and no such limitation is to be inferred. The systems described herein are capable of considerable modification, alteration, and equivalents in form and function, as will occur to those ordinarily skilled in the pertinent arts in considering the present disclosure. The depicted and described embodiments are examples only, and are in no way exhaustive of the scope of the claims.

The foregoing detailed description has set forth various embodiments of the systems described herein via the use of block diagrams, flowcharts, and examples. It will be understood by those within the art that each block diagram component, flowchart step, operation and/or component illustrated by the use of examples can be implemented (individually and/or collectively) by a wide range of hardware, software, firmware, or any combination thereof.

The systems described herein have been described in the context of fully functional computer systems; however, those skilled in the art will appreciate that the systems described herein are capable of being distributed as a program product in a variety of forms, and that the systems described herein apply equally regardless of the particular type of computer-readable media used to actually carry out the distribution. Examples of computer-readable media include computer-readable storage media, as well as media storage and distribution systems developed in the future.

The above-discussed embodiments can be implemented by software modules that perform one or more tasks associated with the embodiments. The software modules discussed herein may include script, batch, or other executable files. The software modules may be stored on a machine-readable or computer-readable storage media such as magnetic floppy disks, hard disks, semiconductor memory (e.g., RAM, ROM, and flash-type media), optical discs (e.g., CD-ROMs, CD-Rs, and DVDs), or other types of memory modules. A storage device used for storing firmware or hardware modules in accordance with an embodiment can also include a semiconductor-based memory, which may be permanently, removably or remotely coupled to a microprocessor/memory system. Thus, the modules can be stored within a computer system memory to configure the computer system to perform the functions of the module. Other new and various types of computer-readable storage media may be used to store the modules discussed herein.

The above description is intended to be illustrative and should not be taken to be limiting. As will be appreciated in light of the present disclosure, other embodiments are possible. Those skilled in the art will readily implement the steps necessary to provide the structures and the methods disclosed herein, and will understand that the process parameters and sequence of steps are given by way of example only and can be varied to achieve the desired structure as well as modifications that are within the scope of the claims. Variations and modifications of the embodiments disclosed herein can be made based on the description set forth herein, without departing from the scope of the claims, giving full cognizance to equivalents thereto in all respects.

Although the systems described herein have been described in connection with several embodiments, these embodiments and their descriptions are not intended to be limited to the specific forms set forth herein. On the contrary, it is intended that such embodiments address such alternatives, modifications, and equivalents as can be reasonably included within the scope of the appended claims.

What is claimed is:

1. A method, implemented in a computer system, comprising:
receiving a first set of descriptors at the computer system, wherein
the computer system is configured to cause presentation of a visual representation in a first user interface displayed by a first remote computer system,
the visual representation is associated with a product and/or service,
the computer system is configured to receive the first set of descriptors via the first user interface, and
each descriptor of the first set of descriptors is associated with the product and/or service by virtue of having been received in response to the presentation of the visual representation in the first user interface;
receiving a second set of descriptors at the computer system, wherein
the computer system is configured to cause presentation of the visual representation in a second user interface displayed by a second remote computer system,
the computer system is configured to receive the second set of descriptors via the second user interface, and
each descriptor of the second set of descriptors is associated with the product and/or service by virtue of having been received in response to the presentation of the visual representation in the second user interface; and
forming a composite set of descriptors, wherein
the forming the composite set of descriptors is performed by a processor of the computer system, and
the forming the composite set of descriptors comprises
forming an aggregated set of descriptors by aggregating one or more descriptors of the first set of descriptors and one or more descriptors of the second set of descriptors, and
performing a weighting operation on the aggregated set of descriptors.

2. The method of claim 1, wherein
each descriptor of the composite set of descriptors is independent of each other descriptor of the composite set of descriptors.

3. The method of claim 2, wherein
each descriptor of the first set of descriptors is independent of each other descriptor of the first set of descriptors, and
each descriptor of the second set of descriptors is independent of each other descriptor of the second set of descriptors.

4. The method of claim 1, wherein
the product and/or service is at least one of
a product,
a service, or
a product-service system.

5. The method of claim 4, wherein
the visual representation is an image, and
the image is one of
an image of a product, or
an image representative of a service.

6. The method of claim 1, further comprising:
causing the visual representation to be presented in the first user interface, wherein
the causing the visual representation to be presented in the first user interface is performed by the processor,
the first user interface is displayed on a display of the first remote computer system, and
the computer system is communicatively coupled to the first remote computer system via a network; and
causing the visual representation to be presented in the second user interface, wherein
the causing the visual representation to be presented in the second user interface is performed by the processor,
the second user interface is displayed on a display of the second remote computer system, and
the computer system is communicatively coupled to the second remote computer system via the network.

7. The method of claim 1, further comprising:
storing the first set of descriptors in a storage unit of the computer system;
storing the second set of descriptors in the storage unit;
retrieving the first set of descriptors from the storage unit; and
retrieving the second set of descriptors from the storage unit.

8. The method of claim 1, wherein the aggregating further comprises:
filtering the first set of descriptors and the second set of descriptors, using one or more
descriptor characteristics, wherein
the filtering is performed such that
each descriptor of the first set of descriptors is independent of each other descriptor of the first set of descriptors, and
each descriptor of the second set of descriptors is independent of each other descriptor of the second set of descriptors.

9. The method of claim 8, wherein
the one or more descriptor characteristics describe an n-dimensional description space.

10. The method of claim 1, wherein the forming the composite set of descriptors further comprises:
determining a relevance value for each descriptor in the aggregated set of descriptors,
wherein
the relevance value represents a relevance of the each descriptor in the aggregate set of descriptors with respect to the product and/or service.

11. The method of claim 10, wherein the forming the composite set of descriptors further comprises:
filtering the aggregate set of descriptors, wherein
the filtering is based, at least in part, on the relevance value for the each descriptor in the aggregate set of descriptors, and
the filtering results in a number of descriptors in the composite set of descriptors being less than a number of descriptors in the aggregate set of descriptors.

12. The method of claim 11, wherein
the filtering is performed such that each descriptor of the aggregate set of descriptors is independent of each other descriptor of the aggregate set of descriptors, and
the relevance value for the each descriptor in the aggregated set of descriptors represents a strength of correlation between the each descriptor in the aggregated set of descriptors and the product and/or service.

13. The method of claim 11, wherein the forming the composite set of descriptors further comprises:
ordering the composite set of descriptors using the relevance values.

14. The method of claim 1, wherein
the weighting operation generates a set of weighting values,
the weighting operation assigns a weight to each descriptor of the aggregate set of descriptors, and
the forming further comprises
generating a ranked list of descriptors by ranking the descriptors in the aggregate set of descriptors, using the set of weighting values, wherein
the ranking results in the composite set of descriptors being in a rank order.

15. The method of claim 14, wherein the forming further comprises:
for each descriptor in the composite set of descriptors,
determining a relevance value for the each descriptor in the composite set of descriptors, wherein
the relevance value is determined with respect to at least one other descriptor in the composite set of descriptors; and
revising the rank order of the composite set of descriptors, wherein the revising is based, at least in part, on the relevance values.

16. The method of claim 15, wherein the determining the relevance value comprises:
for each descriptor in the composite set of descriptors,
determining a frequency of occurrence of the each descriptor in the composite set of descriptors in the first set of descriptors, and
determining a frequency of occurrence of the each descriptor in the composite set of descriptors in the second set of descriptors.

17. A computer program product comprising:
a plurality of instructions, comprising
a first set of instructions, executable on a computer system, configured to receive a first set of descriptors at the computer system, wherein
the computer system is configured to cause presentation of a visual representation in a first user interface displayed by a first remote computer system,
the visual representation is associated with a product and/or service,
the computer system is configured to receive the first set of descriptors via the first user interface, and
each descriptor of the first set of descriptors is associated with the product and/or service by virtue of having been received in response to the presentation of the visual representation in the first user interface,
a second set of instructions, executable by the computer system, configured to receive a second set of descriptors at the computer system, wherein
the computer system is configured to cause presentation of the visual representation in a second user interface displayed by a second remote computer system,
the computer system is configured to receive the second set of descriptors via the second user interface, and
each descriptor of the second set of descriptors is associated with the product and/or service by virtue of having been received in response to the presentation of the visual representation in the second user interface, and
a third set of instructions, executable by the computer system, configured to form a composite set of descriptors, wherein
the third set of instructions comprises
a first subset of instructions, executable by the computer system, configured to form an aggregated set of descriptors by aggregating one or more descriptors of the first set of descriptors and one or more descriptors of the second set of descriptors, and
a second subset of instructions, executable by the computer system, configured to perform a weighting operation on the aggregated set of descriptors; and
a computer-readable storage medium, wherein the instructions are encoded in the computer-readable storage medium.

18. The computer program product of claim 17, wherein the instructions further comprise:
a fourth set of instructions, executable by the computer system, configured to cause the visual representation to be presented in the first user interface, wherein
the first user interface is displayed on a display of the first remote computer system, and
the computer system is communicatively coupled to the first remote computer system via a network; and
a fifth set of instructions, executable by the computer system, configured to cause the visual representation to be presented in the second user interface, wherein
the second user interface is displayed on a display of the second remote computer system, and
the computer system is communicatively coupled to the second remote computer system via the network.

19. The computer program product of claim 17, wherein
the weighting operation generates a set of weighting values,
the weighting operation assigns a weight to each descriptor of the aggregate set of descriptors,
the third set of instructions further comprise
a third subset of instructions, executable by the computer system, configured to generate a ranked list of descriptors by ranking the descriptors in the aggregate set of descriptors, using the set of weighting values, wherein
the ranking results in the composite set of descriptors being in a rank order, and
the instructions further comprise
a fourth set of instructions, executable by the computer system, configured to, for each descriptor in the composite set of descriptors, determine a relevance value for the each descriptor in the composite set of descriptors, wherein
the relevance value is determined with respect to at least one other descriptor in the composite set of descriptors, and
a fifth set of instructions, executable by the computer system, configured to revise the rank order of the composite set of descriptors, wherein
the fifth set of instructions are configured to use the relevance values.

20. A computer system comprising:
one or more processors;
a computer-readable storage medium coupled to the one or more processors; and
a plurality of instructions, encoded in the computer-readable storage medium and configured to cause the one or more processors to
receive a first set of descriptors at the computer system, wherein
the computer system is configured to cause presentation of a visual representation in a first user interface displayed by a first remote computer system,
the visual representation is associated with a product and/or service,
the computer system is configured to receive the first set of descriptors via the first user interface, and
each descriptor of the first set of descriptors is associated with the product and/or service by virtue of having been received in response to the presentation of the visual representation in the first user interface,
receive a second set of descriptors at the computer system, wherein
the computer system is configured to cause presentation of the visual representation in a second user interface displayed by a second remote computer system,
the computer system is configured to receive the second set of descriptors via the second user interface, and
each descriptor of the second set of descriptors is associated with the product and/or service by virtue of having been received in response to the presentation of the visual representation in the second user interface, and
form a composite set of descriptors, wherein
the instructions configured to cause the one or more processors to form the composite set of descriptors comprises instructions configured to cause the one or more processors to
form an aggregated set of descriptors by aggregating one or more descriptors of the first set of descriptors and one or more descriptors of the second set of descriptors, and
perform a weighting operation on the aggregated set of descriptors.
